(19) United States
(12) Patent Application Publication
(10) Pub. No.: US 2025/0050616 A1
(43) Pub. Date: Feb. 13, 2025

(54) THERMOPLASTIC COMPOSITES WITH IMPROVED INDUCTION HEATING PROPERTIES

(71) Applicant: Toray Advanced Composites USA Inc., Morgan Hill, CA (US)

(72) Inventors: Kapil Milind INAMDAR, Newbury Park, CA (US); Saurabh Vaidya, Thousand Oaks, CA (US); Dickie DeWayne Howell, Arvada, CO (US)

(73) Assignee: Toray Advanced Composited USA Inc., Morgan Hill, CA (US)

(21) Appl. No.: 18/799,789

(22) Filed: Aug. 9, 2024

Related U.S. Application Data
(60) Provisional application No. 63/532,246, filed on Aug. 11, 2023.

(51) Int. Cl. B32B 5/12; B32B 5/26; B32B 37/02; B32B 37/06; B32B 38/00

(52) U.S. Cl. CPC B32B 5/12; B32B 5/271; B32B 37/02; B32B 37/06; B32B 38/0008; B32B 2262/02; B32B 2262/106; B32B 2305/22; B32B 2307/514

(57) ABSTRACT

Described herein are thermoplastic composites and methods of making thereof. The thermoplastic composites disclosed herein can include at least one randomly-oriented carbon fiber layer in the laminate to improve induction heating efficiency of the thermoplastic composite.

### CROSS-REFERENCE TO RELATED APPLICATION

This application claims the benefit of U.S. Provisional Application No. 63/532,246, filed Aug. 11, 2023, the entire contents of which is incorporated herein by reference.

### FIELD OF THE DISCLOSURE

This disclosure relates to thermoplastic composites and methods of making these thermoplastic composites by induction heating. More particularly, this disclosure relates to thermoplastic composites and methods of making thermoplastic composites by induction heating utilizing at least one randomly-oriented carbon fiber layer in the laminate stack to improve induction heating properties.

### BACKGROUND OF THE DISCLOSURE

Unidirectional tapes (UD tapes) are composite materials with unidirectionally aligned reinforcing fibers that are typically impregnated with a polymer resin. When compared to conventional materials (e.g., aluminum and steel and their various alloys), UD tapes have various structural advantages such as high stiffness and strength with low weight. Thus, UD tapes are used in a wide range of applications including in the aerospace, automotive, consumer electronic industries, and other industries where lightweight and high-strength structures are essential.

Subsequent processing of these UD tapes can include tacking, tape placement, tape laying, consolidation, or welding, among others. Specifically, the UD tapes are often heated such that the polymers of the tape can melt and/or soften so that adjacent layers of tape may bind, laminate, and/or weld together.

Induction welding is a process that can join two or more carbon fiber composite components (e.g., woven carbon fiber fabric, UD carbon fiber tape) through induction heating. As shown in FIG. 1, during induction heating, a high-frequency alternating current can be passed through a conductive coil 1, thereby creating an electromagnetic field 2 that induces electrical currents 3 in the carbon fibers of the carbon fiber composite components 4A and 4B. This can lead to the rapid heating and softening of the surrounding polymer. As a result, the fibers and/or polymers of the carbon fiber composite components can fuse together (under pressure), forming a strong and durable bond or weld. Induction welding can offer several advantages compared to traditional bonding methods such as adhesive bonding or mechanical fastening. These advantages include, but are not, limited to fast and efficient joining, reduced weight, and minimal damage to the carbon fiber structure.

### SUMMARY OF THE DISCLOSURE

To improve induction heating (e.g., achieving a higher rate of heating with induction welding), Applicant has discovered that at least one layer/ply of a traditional thermoplastic UD tape laminate can be replaced with at least one randomly-oriented (e.g., non-woven) fiber based layer/ply impregnated with the same or different polymer as the other layers/plies in the UD tape laminate. In some embodiments, the at least one randomly-oriented fiber based layer/ply can be used in addition to the existing UD tape layers/plies in the laminate. Replacing at least one UD layer/ply with at least one randomly-oriented fiber based layer/ply and/or incorporating at least one randomly-oriented fiber based layer/ply in the laminate can increase the rate of induction heating. Because the at least one randomly-oriented fiber layer can have carbon fibers in any direction (i.e., the Z direction in addition to comingled fibers in the X and Y direction), higher eddy current generation was found, thereby increasing the rate and temperature of induction heating as explained in more detail herein.

As such, Applicant discovered that a higher induction heating temperature can be achieved in a shorter amount of time by implementing at least one randomly-oriented fiber layer at the point of joining/welding/bonding. For example, if two laminates are to be joined together, at least one randomly-oriented fiber layer can be at the interface of the two laminates for induction welding. This can help obtain better welds (i.e., welded joints) between the two composites (e.g., layers, laminates, stacks) and on an industrial scale this can also help optimize the process cycle on how much/fast composites can be produced.

Besides increasing the rate and temperature of heating with induction welding, Applicant has discovered that utilizing a randomly-oriented fiber layer in the laminate stack can: (1) create highly focused inductive resistance, thereby reducing the heating losses due to thermal losses during induction welding; (2) create faster cycle time; and/or (3) increase the ease of manufacturing these complex parts by having the randomly-oriented fiber layer/ply act as a stiffener to the overall laminate.

In some embodiments, a method of producing a thermoplastic composite includes preparing a first laminate comprising: a first layer comprising a first plurality of unidirectional fibers and a first polymer; and a second layer comprising randomly-oriented carbon fibers and a second polymer, wherein the second layer covers at least a portion of a surface of the first layer; preparing a second laminate comprising: a third layer comprising a second plurality of unidirectional fibers and a third polymer; placing the first laminate in contact with the second laminate such that the second layer of the first laminate contacts the second laminate; inducing electrical currents in the randomly-oriented carbon fibers of the second layer via an alternating electromagnetic field, thereby generating heat in the randomly-oriented carbon fibers of the second layer; and melting and/or softening the first, second, and third polymer with the heat generated by the randomly-oriented carbon fibers, thereby welding the first laminate to the second laminate. In some embodiments, the second laminate further comprises a fourth layer comprising randomly-oriented carbon fibers and a fourth polymer. In some embodiments, the method includes placing the first laminate in contact with the second laminate such that the fourth layer of the second laminate contacts the second layer of the first laminate. In some embodiments, the method includes inducing electrical currents in the randomly-oriented carbon fibers of the fourth layer via an alternating electromagnetic field, thereby generating heat in the randomly-oriented carbon fibers of the fourth layer. In some embodiments, the method includes melting and/or softening the first, second, third, and fourth polymers with the heat generated by the randomly-oriented carbon fibers of the second and fourth layers, thereby welding the first laminate to the second laminate. In some embodiments, at least a portion of the first laminate overlaps with at least a portion of the second laminate when the first laminate is placed in contact with the second laminate, and the first laminate is welded to the second laminate at the portions that overlap. In some embodiments, the randomly-oriented carbon fibers are discontinuous and/or chopped carbon fibers. In some embodiments, the first and second plurality of unidirectional fibers comprises carbon fibers, glass fibers, or combinations thereof. In some embodiments, the first, second, third, and/or fourth polymers are the same polymer. In some embodiments, welding the first laminate to the second laminate includes applying pressure to the first and/or second laminate to push the first laminate and second laminate together.

In some embodiments, a method of producing a thermoplastic composite includes preparing a lay-up comprising: a first layer comprising a first plurality of unidirectional fibers and a first polymer; a second layer comprising a second plurality of unidirectional fibers and a second polymer; and at least one third layer comprising randomly-oriented carbon fibers and a third polymer, wherein the at least one third layer is between the first layer and the second layer in the lay-up; inducing electrical currents in the randomly-oriented carbon fibers of the at least one third layer via an alternating electromagnetic field, thereby generating heat in the randomly-oriented carbon fibers of the at least one third layer; and melting and/or softening the first, second, and third polymer of the third layer with the heat generated by the randomly-oriented carbon fibers, thereby welding the at least one third layer to the first layer and the second layer. In some embodiments, the randomly-oriented carbon fibers are discontinuous and/or chopped carbon fibers. In some embodiments, the first and second plurality of unidirectional fibers comprises carbon fibers, glass fibers, or combinations thereof. In some embodiments, the first, second, and third polymers are the same polymers. In some embodiments, at least a portion of the first layer overlaps with at least a portion of the at least one third layer, at least a portion of the second layer overlaps with at least a portion of the at least one third layer, and the at least one third layer is welded to the first layer and the second layer at the portions that overlap.

In some embodiments, a thermoplastic composite includes a first layer comprising a first plurality of unidirectional fibers and a first polymer; a second layer comprising a second plurality of unidirectional fibers and a second polymer; and at least one third layer comprising randomly-oriented carbon fibers and a third polymer, wherein the at least one third layer is between the first layer and the second layer and the at least one third layer is welded to the first and second layers. In some embodiments, the at least one third layer comprises at least two layers comprising randomly-oriented carbon fibers and a third polymer, wherein one of the at least two layers is welded to the first layer and the other one of the at least two layers is welded to the second layer. In some embodiments, one of the at least two layers covers a portion of a surface of the first layer, and the other one of the at least two layers covers a portion of a surface of the second layer. In some embodiments, the randomly-oriented carbon fibers are discontinuous and/or chopped carbon fibers. In some embodiments, the first and second plurality of unidirectional fibers comprises carbon fibers, glass fibers, or combinations thereof. In some embodiments, the first, second, and third polymers are the same polymers. In some embodiments, the welding is formed from induction welding.

In some embodiments, a method of producing a thermoplastic composite includes preparing a first laminate comprising: a first layer comprising a first woven fabric comprising a first plurality of fibers and a first polymer; and a second layer comprising randomly-oriented carbon fibers and a second polymer, wherein the second layer covers at least a portion of a surface of the first layer; preparing a second laminate comprising: a third layer comprising a second woven fabric comprising a second plurality of fibers and a third polymer; placing the first laminate in contact with the second laminate such that the second layer of the first laminate contacts the second laminate; inducing electrical currents in the randomly-oriented carbon fibers of the second layer via an alternating electromagnetic field, thereby generating heat in the randomly-oriented carbon fibers of the second layer; and melting and/or softening the first, second, and third polymer with the heat generated by the randomly-oriented carbon fibers, thereby welding the first laminate to the second laminate. In some embodiments, the second laminate further comprises a fourth layer comprising randomly-oriented carbon fibers and a fourth polymer. In some embodiments, the method includes placing the first laminate in contact with the second laminate such that the fourth layer of the second laminate contacts the second layer of the first laminate. In some embodiments, the method includes inducing electrical currents in the randomly-oriented carbon fibers of the fourth layer via an alternating electromagnetic field, thereby generating heat in the randomly-oriented carbon fibers of the fourth layer. In some embodiments, melting and/or softening the first, second, third, and fourth polymers with the heat generated by the randomly-oriented carbon fibers of the second and fourth layers, thereby welding the first laminate to the second laminate. In some embodiments, at least a portion of the first laminate overlaps with at least a portion of the second laminate when the first laminate is placed in contact with the second laminate, and the first laminate is welded to the second laminate at the portions that overlap. In some embodiments, the randomly-oriented carbon fibers are discontinuous and/or chopped carbon fibers. In some embodiments, the first and second plurality of unidirectional fibers comprises carbon fibers, glass fibers, or combinations thereof. In some embodiments, the first, second, third, and/or fourth polymers are the same polymer.

In some embodiments, a method of producing a thermoplastic composite includes preparing a first laminate comprising: a first layer comprising a first plurality of unidirectional fibers and a first polymer; and a second layer comprising a first portion and a second portion, wherein the first portion comprises randomly-oriented carbon fibers and a second polymer and the second portion comprises a second plurality of unidirectional fibers and a third polymer; preparing a second laminate comprising: a third layer comprising a third plurality of unidirectional fibers and a fourth polymer; placing the first laminate in contact with the second laminate such that the second layer of the first laminate contacts the second laminate; inducing electrical currents in the randomly-oriented carbon fibers of the second layer via an alternating electromagnetic field, thereby generating heat in the randomly-oriented carbon fibers of the second layer; and melting and/or softening the first, second, third, and fourth polymers with the heat generated by the randomly-oriented carbon fibers, thereby welding the first laminate to the second laminate. In some embodiments, the second laminate further comprises a fourth layer comprising a first portion and a second portion, wherein the first portion comprises randomly-oriented carbon fibers and a fifth polymer and the second portion comprises a fourth plurality of unidirectional fibers and a sixth polymer. In some embodiments, the method includes placing the first laminate in contact with the second laminate such that the first portion of the second layer of the first laminate contacts the first portion of the fourth layer of the second laminate. In some embodiments, the method includes inducing electrical currents in the randomly-oriented carbon fibers of the fourth layer via an alternating electromagnetic field, thereby generating heat in the randomly-oriented carbon fibers of the fourth layer. In some embodiments, melting and/or softening the first, second, third, fourth, fifth, and sixth polymers with the heat generated by the randomly-oriented carbon fibers of the second and fourth layers, thereby welding the first laminate to the second laminate. In some embodiments, at least a portion of the first laminate overlaps with at least a portion of the second laminate when the first laminate is placed in contact with the second laminate, and the first laminate is welded to the second laminate at the portions that overlap. In some embodiments, the randomly-oriented carbon fibers are discontinuous and/or chopped carbon fibers. In some embodiments, the first and second plurality of unidirectional fibers comprises carbon fibers, glass fibers, or combinations thereof. In some embodiments, the first, second, third, fourth, fifth, and/or sixth polymers are the same polymer. In some embodiments, welding the first laminate to the second laminate includes applying pressure to the first and/or second laminate to push the first laminate and second laminate together.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

It is understood that aspects and embodiments described herein include “consisting” and/or “consisting essentially of” aspects and embodiments. For all methods, systems, compositions, tapes, and devices described herein, the methods, systems, compositions, tapes, and devices can either comprise the listed components or steps, or can “consist of” or “consist essentially of” the listed components or steps. When a system, composition, laminate, composite, tape, or device is described as “consisting essentially of” the listed components, the system, composition, laminate, composite, tape, or device contains the components listed, and may contain other components which do not substantially affect the performance of the system, composition, laminate, composite, tape, or device, but either do not contain any other components which substantially affect the performance of the system, composition, laminate, composite, tape, or device other than those components expressly listed; or do not contain a sufficient concentration or amount of the extra components to substantially affect the performance of the system, composition, laminate, composite, tape, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

In the disclosure, “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

Additional advantages will be readily apparent to those skilled in the art from the following detailed description. The examples and descriptions herein are to be regarded as illustrative in nature and not restrictive.

### BRIEF DESCRIPTION OF THE FIGURES

Various embodiments are described, by way of example only, with reference to the accompanying drawings, in which:

FIG. 1 represents an exemplary schematic of induction welding two carbon fiber composite components together in accordance with some embodiments disclosed herein.

FIG. 2A is an induction heating infrared image taken from sample C1 at 300 amps and 10 seconds of Test 1 in accordance with some embodiments disclosed herein.

FIG. 2B is an induction heating infrared image taken from sample C1 at 500 amps and 3 seconds of Test 1 in accordance with some embodiments disclosed herein.

FIG. 3A is an induction heating infrared image taken from sample C2 at 300 amps and 10 seconds of Test 1 in accordance with some embodiments disclosed herein.

FIG. 3B is an induction heating infrared image taken from sample C2 at 500 amps and 3 seconds of Test 1 in accordance with some embodiments disclosed herein.

FIG. 4A illustrates a bar graph showing the average peak temperatures measured from samples C1 and C2 of Test 1 in accordance with some embodiments disclosed herein.

FIG. 4B illustrates a graph showing the heating rates measured from samples C1 and C2 of Test 1 in accordance with some embodiments disclosed herein.

FIG. 5A is an induction heating infrared image taken from sample C3 at 300 amps and 10 seconds of Test 1 in accordance with some embodiments disclosed herein.

FIG. 5B is an induction heating infrared image taken from sample C3 at 500 amps and 3 seconds of Test 1 in accordance with some embodiments disclosed herein.

FIG. 6A is an induction heating infrared image taken from sample C4 at 300 amps and 10 seconds of Test 1 in accordance with some embodiments disclosed herein.

FIG. 6B is an induction heating infrared image taken from sample C4 at 500 amps and 3 seconds of Test 1 in accordance with some embodiments disclosed herein.

FIG. 7A is an induction heating infrared image taken from sample C5 at 300 amps and 10 seconds of Test 1 in accordance with some embodiments disclosed herein.

FIG. 7B is an induction heating infrared image taken from sample C5 at 500 amps and 3 seconds of Test 1 in accordance with some embodiments disclosed herein.

FIG. 8A illustrates a bar graph showing the average peak temperatures measured from samples C3, C4, and C5 of Test 1 in accordance with some embodiments disclosed herein.

FIG. 8B illustrates a graph showing the heating rates measured from samples C3, C4, and C5 of Test 1 in accordance with some embodiments disclosed herein.

FIG. 9A is an induction heating infrared image taken from sample C6 at 300 amps and 10 seconds of Test 1 in accordance with some embodiments disclosed herein.

FIG. 9B is an induction heating infrared image taken from sample C6 at 500 amps and 3 seconds of Test 1 in accordance with some embodiments disclosed herein.

FIG. 10 illustrates a bar graph showing the peak temperatures of the various panels and average of the panels measured from samples C1-C6 of Test 1 in accordance with some embodiments disclosed herein.

FIG. 11 illustrates a bar graph showing the peak temperatures measured from samples C1-C6 of Test 1 in accordance with some embodiments disclosed herein.

FIG. 12 illustrates a bar graph showing the average peak temperatures measured from samples C1-C6 of Test 1 in accordance with some embodiments disclosed herein.

FIG. 13A illustrates at least one randomly-oriented fiber layer covering an exterior entire surface of a laminate in accordance with some embodiments disclosed herein.

FIG. 13B illustrates at least one randomly-oriented fiber layer covering a portion of an exterior surface of a laminate in accordance with some embodiments disclosed herein.

FIG. 13C illustrates at least one randomly-oriented fiber internal layer of a laminate in accordance with some embodiments disclosed herein.

FIG. 14 illustrates an exemplary induction heating set up in accordance with some embodiments disclosed herein.

FIG. 15 illustrates a fiber areal weight (FAW) in gsm for various samples in accordance with some embodiments disclosed herein.

FIG. 16 illustrates a bar graph showing the average peak temperatures measured from samples C1-C5 in accordance with some embodiments disclosed herein.

FIG. 17 illustrates a line graph showing the average peak temperatures measured from samples C1-C5 in accordance with some embodiments disclosed herein.

FIG. 18 illustrates a bar graph showing the peak temperature percent increase from C3 for samples C3-C5 in accordance with some embodiments disclosed herein.

FIG. 19 illustrates a bar graph showing the peak temperature percent increase from C1 for samples C1-C2 in accordance with some embodiments disclosed herein.

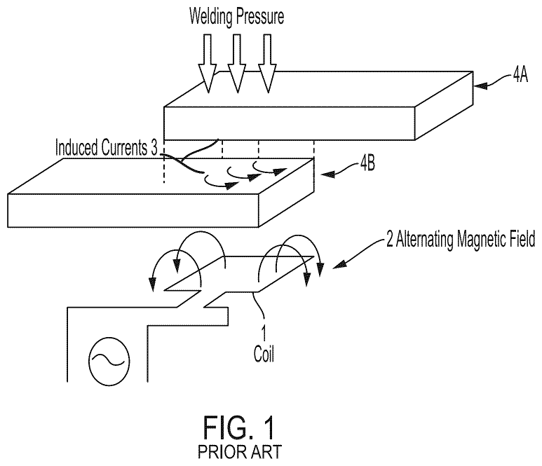

In the Figures, like references refer to like components unless stated differently herein.

### DETAILED DESCRIPTION OF EXEMPLARY EMBODIMENTS

Thermoplastic polymer-based composite parts can be bonded or welded together using the concept of induction of eddy currents to generate heat for localized melting of thermoplastic polymer materials. When electrically conductive, non-magnetic materials (e.g., carbon fibers) are exposed to alternating magnetic fields, eddy currents can be induced and the material itself can be heated due to resistive losses of the eddy currents. In other words, the concept of induction welding can rely on the resistivity of the materials of construction in the composite part, in that, the resistance to passage of current within the constituent materials results in localized heat generation within the material.

Nonmagnetic materials and electrical insulators such as thermoplastic polymers can be induction welded together when they contain carbon fibers because the carbon fibers act as susceptors that absorb the electromagnetic energy (from the induction coil), generate heat, and lose that heat to the surrounding thermoplastic polymer material by thermal conduction. For example, induced eddy currents can resistively heat the carbon fibers in the thermoplastic polymer. These heated carbon fibers can then lose their heat to the surrounding thermoplastic polymer by conduction. This, in turn, can result in localized softening, and under the right conditions, melting of the thermoplastic polymer. Two composite part surfaces in contact with each other under controlled conditions can be joined through such localized heating and softening/melting of the thermoplastic polymers.

The induction welding peak temperature attained can also be a function of the induction welding parameters such as the type such as the type and design of the induction heating coil, the frequency of the electrical current, the rate or speed of movement of the coil over the area to be welded, the type of materials used in the laminates being induction welded, or combinations thereof, among others. In some embodiments, the induction welding peak temperature referred herein can be the highest temperature observed/recorded during an induction heating or induction welding process as recorded by a temperature reading/recording tool such as an infrared camera and/or thermocouple.

Induction heating may be possible for carbon fiber thermoplastics when there are closed loops for the induced eddy currents to flow. In other words, eddy currents flowing along the carbon fibers should be able to return along another set of fibers. For example, a conductive loop can be created when there is sufficient galvanic connection between the carbon fibers due to their contact. Without sufficient carbon fiber contact, the current can complete the closed loop by flowing through the thermoplastic polymer because of capacitive coupling of the carbon fibers. In some embodiments, the Z-direction or through thickness conductivity can be a dominate factor in determining the induction welding peak temperature at the surface to be welded. In addition, other factors impact the induction welding peak temperature of UD tape composites including, but not limited to, the type of fiber reinforcement, the amount of fiber reinforcement, and/or the type of polymer. In the case of stacked layers of unidirectional tapes (UD tapes), there is minimal to no overlap between the reinforcing carbon fibers. This can bring limitations on the attainable induction welding peak temperature.

Traditional unidirectional tape laminates have inherent material characteristics related to rate of heating and achievable peak temperature during heating and induction welding. Applicant has discovered that the limitations in induction heating of UD tape-based laminates can be overcome by introducing at least one randomly-oriented fiber ply/layer in the laminate structure. In some embodiments, the randomly-oriented fiber ply/layer(s) can replace one or more UD tape layers in the laminate construction. In some embodiments, the randomly-oriented fiber ply/layer(s) can be used in addition to the existing UD tape layers in the laminate construction. In some embodiments, the randomly-oriented carbon fiber ply/layer(s) can be used in combination with material forms other than UD tape such as woven fabrics (e.g., carbon fiber woven fabrics or woven UD tapes). A woven UD tape can be a fabric that is formed from taking UD tapes and weaving them together. In some embodiments, the at least one randomly-oriented fiber layer can be at the point of joining/welding/bonding multiple layers and/or laminates together.

As described in more detail herein, Applicant discovered that randomly-oriented fiber layers can be leveraged for their form and the inherent overlap and higher proximity of physical contact between the discontinuous fibers for increased and improved efficiency of induction rates resulting in higher efficiencies and much higher attainable peak temperatures. Because the randomly-oriented fiber layer can have at least some portion of the fibers (e.g., carbon fibers) in the Z direction (in addition to at least a portion of the fibers in the X and Y directions), higher eddy current generation can occur, thereby increasing the rate and temperature of heating due to the at least one randomly-oriented fiber layer in the laminate. For example, the fibers in the randomly-oriented fiber layer(s) can have fiber oriented in isometric orientation and/or have some z-directional orientation, x-directional orientation, and/or y-directional orientation. In some embodiments, the fibers in the randomly-oriented fiber layer(s) can have fiber orientation isometric in a 3D global matrix. Specifically, the at least one randomly-oriented fiber layer can heat up first grabbing up the energy that the coil (of the induction heating/welding device) is producing and then heats the polymer up surrounding the randomly-oriented fiber layer(s). The polymer(s) in the randomly-oriented fiber (and heat from fibers) can then heat other layers of the laminate (for potential additional bonding/welding/joining). In addition, this highly focused inductive resistance can reduce the heating losses due to thermal losses during induction welding. Furthermore, adding a randomly-oriented fiber layer can increase cycle time of induction welding.

Described herein are thermoplastic composites and methods of producing thermoplastic composites by induction heating utilizing at least one randomly-oriented fiber layer. Specifically, Applicant discovered that a higher rate of heating for induction welding two thermoplastic components (e.g., layers, laminates, etc.) together to form a thermoplastic composite can be achieved by adding at least one randomly-oriented fiber layer.

In order to produce a thermoplastic composite, a lay-up stack of two or more thermoplastic layers (i.e., prepregs) can be prepared and/or a laminate of two or more thermoplastic layers can be prepared. The laminates can be prepared by any process known in the art. In some embodiments, the lay-up stack(s) can be consolidated together (one at a time or all at once) (by any known method) to form the laminate(s). The lay-up can be prepared by any process known in the art including manual and automatic fabrication techniques. In some embodiments, manual fabrication can include manual cutting and placement of layer to a surface (such as that of a mandrel). Additional layers can be added onto a prior layer to provide the lay-up with a desired thickness and sequence (e.g., fiber orientation). In some embodiments, automated fabrication techniques can include, but are not limited to, automated tape layup (ATL) and automated fiber placement (AFP).

The lay-up stack(s) and/or laminate(s) can include a plurality of layers or plies. In some embodiments, at least one of the layers in the lay-up stack(s) and/or laminate(s) can be a unidirectional fiber layer. In some embodiments, the lay-up stack(s) and/or laminate(s) can include a plurality of unidirectional fiber layers. In some embodiments, the unidirectional fiber layer(s) can include a plurality of unidirectional fibers (e.g., reinforcing fibers). In some embodiments, the unidirectional fibers of the unidirectional fiber layer(s) can be arranged to lie in a unidirectional orientation. In some embodiments, at least about 75%, at least about 80%, at least about 85%, at least about 90%, at least about 95%, or at least 98% of the fibers of the unidirectional fiber layer can lie in a unidirectional orientation. There may be no specific limitations or restrictions on the type or types of fibers used in the unidirectional fiber layers disclosed herein. In some embodiments, the fibers can include glass fiber, carbon fiber, graphite fiber, aramid fiber, boron fiber, alumina fiber, silicon carbide fiber, or combinations thereof. In some embodiments, the fibers can be virgin fibers, post-industrial fibers, and/or recycled fibers. In some embodiments, the unidirectional fiber layer can include at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 66 wt. %, at least about 70 wt. %, at least about 75 wt. %, at least about 80 wt. %, at least about 85 wt. %, or at least about 90 wt. % fibers. In some embodiments, the unidirectional fiber layer can include at most about 95 wt. %, at most about 90 wt. %, at most about 85 wt. %, at most about 80 wt. %, at most about 75 wt. %, at most about 70 wt. %, at most about 65 wt. %, at most about 50 wt. %, at most about 45 wt. %, or at most about 40 wt. % fibers.

In some embodiments, the unidirectional fiber layer(s) can include at least one polymer. In some embodiments, the plurality of unidirectional fibers can be embedded and/or dispersed in the at least one polymer. In some embodiments, the at least one polymer can be a polymer resin such as a neat polymer resin or a polymer resin compounded with additives disclosed herein. In some embodiments, the at least one polymer can be a plurality of polymer particles. In some embodiments, the at least one polymer can include a thermoplastic polymer. In some embodiments, the at least one polymer can be polyamides, polycarbonates, polyacetals, polyphenylene oxides, polyphenylene sulfides, polyarylates, polyesters, polyamideimides, polyimides, polyetherimides, polyimides with a phenyltrimethylindane structure, polysulfones, polyethersulfones, polyetherketones, polyetheretherketones, polyaramids, polyethernitriles, polybenzimidazoles, or combinations thereof. In some embodiments, the at least one polymer can include polyarylether ketone (PAEK), polyphenylene sulfide (PPS), polyethersulfone (PES or PESU), polyethylenimine (PEI), polysulfone (PSU), or combinations thereof. In some embodiments, the at least one polymer can include poly-ether-ketone (PEK), polyether-ether-ketone (PEEK), poly-ether-ether-ketone-ketone (PEEKK), poly-ether-ether-ketone-ketone (PEKK), poly-ether-ketone-ether-ketone-ketone (PEKEKK), poly-ether-ether-ketone-ether-ketone (PEEKEK), poly-ether-ether-ether-ketone (PEEEK), and poly-ether-diphenyl-ether-ketone (PEDEK), polyaryletherketone (PAEK)-based polymeric material with reactive (end) groups, or combinations thereof. In some embodiments, the PAEK-based polymers can include a range of variants commonly called Low-Melt Polyaryletherketone (LMPAEK™), which can have lower melting temperature for faster processing but comparable mechanical properties compared to other PAEK-based polymers such as PEEK and PEKK. In some embodiments, the unidirectional fiber layer can include at least about 5 wt. %, at least about 10 wt. %, at least about 15 wt. %, at least about 20 wt. %, at least about 25 wt. %, at least about 30 wt. %, at least about 34 wt. %, at least about 35 wt. %, at least about 40 wt. %, at least about 50 wt. %, at least about 55 wt. %, at least about 60 wt. %, at least about 65 wt. %, at least about 70 wt. %, at least about 75 wt. %, or at least about 80 wt. % at least one polymer. In some embodiments, the unidirectional fiber layer can include at most about 80 wt. %, at most about 75 wt. %, at most about 70 wt. %, at most about 65 wt. %, at most about 60 wt. %, at most about 55 wt. %, at most about 50 wt. %, at most about 45 wt. %, at most about 40 wt. %, at most about 35 wt. %, at most about 30 wt. %, at most about 25 wt. %, at most about 20 wt. %, at most about 15 wt. %, or at most about 10 wt. % at least one polymer.

In some embodiments, the unidirectional fiber layer(s) can include additives. As stated above, in some embodiments, the at least one polymer can be compounded with additives. In some embodiments, the additives can enhance performance of the consolidated laminate, for example. In some embodiments, the additives can be electrically conductive, dielectric, non-conductive, and/or a combination of other types of additives. In some embodiments, the additives can impart properties other than or in combination with conductivity. In some embodiments, additives can be added to impart insulating properties, thermal properties, chemical properties, and/or mechanical properties. For example, additives can be added to impart strength, toughness, thermal stability, CTE, and/or resistance to environmental degradation, among others. In some embodiments, the additives can be electrically conductive additives for enhanced electrical conductivity of the unidirectional fiber layer. For example, the conductive additives can include carbon particles, carbon black graphene, carbon nanotubes (CNT), milled carbon fiber, milled carbon fiber prepreg, or combinations thereof. In some embodiments, the additives can have a characteristic length or diameter of about 20 nm to 1 micron. In some embodiments, the characteristic length can be the largest dimension of the additive. In some embodiments, the additives can be mixed and/or melt mixed with the at least one polymer before impregnation. In some embodiments, the additives (and at least one polymer) can be well dispersed in the unidirectional fiber layer. In some embodiments, the amount (or concentration) of the additives can depend on how well dispersed the additives are in the unidirectional fiber layer. For example, the amount (or concentration) for percolation can depend on how well dispersed the additives in the unidirectional fiber layer are. As the degree of additive dispersion increases, the concentration/amount of additive to achieve the percolation threshold concentration for electrical conductivity can decrease.

In some embodiments, in the lay-up stack(s) and/or laminate(s) at least two of the unidirectional fiber layers can be positioned to be oriented in two different directions. In this embodiment, the lay-up stack(s) and/or laminate(s) can be multiaxial. In some embodiments, some of the unidirectional fiber layers (or all of the unidirectional fiber layers) can be oriented in different directions, while the others can be oriented in the same direction. In some embodiments, two consecutive unidirectional fiber layers in the lay-up stack may not be oriented in the same direction. In some embodiments, the orientations of the unidirectional fiber layers can be oriented at an angle of 0 degrees, +45 degrees, −45 degrees (corresponding to +135 degrees), and/or +90 degrees to the principal axis of the part being created. For example, the 0 degree orientation can correspond to the axis of the machine fabricating the stack (i.e., the axis corresponding to the direction of travel of the stack during its fabrication). In some embodiments, the principal axis of the part, which is generally the largest axis of the part typically corresponds with 0 degrees. In some embodiments, the lay-up stack can have unidirectional fiber layers oriented quasi-isotropic, symmetrical, and/or other orientations.

In some embodiments, the unidirectional fiber layer(s) can be prepared by any method known in the art. For example, the unidirectional fiber layer(s) can be prepared by impregnating the plurality of unidirectional fibers (i.e., the fiber layer(s)) with the at least one polymer (and additives). Impregnation of the fiber layer can be carried out using any technique known by those of skill in the art including a wet method and a hot melt method (i.e., dry method). In some embodiments, impregnation of the fiber layer can take place in an impregnation bath (e.g., a container or vessel with the impregnation slurry/solution). In some embodiments, the fiber layer can be impregnated with the impregnation slurry/solution by moving or pulling the fiber layer through the impregnation bath. In some embodiments, impregnating the fiber layer with the at least one polymer can form the unidirectional fiber layer. In some embodiments, the wet method can include immersing the fiber layer (e.g., reinforcing fibers) in an impregnation slurry or solution that includes at least one polymer.

In some embodiments, the at least one polymer can be mixed and/or dissolved in the slurry/solution in at least one solvent such as water, methyl ethyl ketone, and/or an alcohol (e.g., methanol, etc.) and then the fiber layer immersed in the slurry/solution. After immersion, the solvent can be removed via evaporation (in an oven for example) to obtain the unidirectional fiber layer. In some embodiments, the hot melt method can include applying the at least one polymer (and additives) using an extruder-based process or coating the fiber layer with the at least one polymer and then heating and applying pressure to the at least one polymer layer/coating and the fiber layer such that the at least one polymer impregnates the fiber layer.

In some embodiments, at least one of the layers in the lay-up stack(s) and/or laminate(s) can be a randomly-oriented fiber layer. In some embodiments, the lay-up stack(s) and/or laminate(s) can include a plurality of randomly-oriented carbon layers. In some embodiments, at least one randomly-oriented fiber layer can be between at least two unidirectional fiber layers in the lay-up stack(s) and/or laminate(s). In some embodiments, at least one randomly-oriented fiber layer can be in contact with at least one unidirectional fiber layer in the lay-up stack(s) and/or laminate(s). In some embodiments, at least one randomly-oriented fiber layer can be in the middle and/or on the end or surface of a lay-up stack(s) and/or laminate(s). In some embodiments, at least one randomly-oriented fiber layer can be on both ends or surfaces of a lay-up stack(s) and/or laminate(s)

In some embodiments, the randomly-oriented fiber layer can include a plurality of fibers (e.g., reinforcing fibers). In some embodiments, the fibers of the randomly-oriented fiber layer can be arranged such that they have a random orientation. For example, the fibers can be all over the layer as in some touching each other, some crossing over each other, some going through the thickness of the layer, etc. In other words, these randomly-oriented fibers can act almost like a woven fabric in terms of uniformity. In some embodiments, the fibers of the randomly-oriented fiber layer can be discontinuous fibers. In some embodiments, the fiber length of the randomly-oriented fiber layer can be shorter than the length of a corresponding UD fiber in a UD tape. For example, in some embodiments, the fiber length of the randomly-oriented fiber layer can be at least about 1 mm, at least about 2 mm, at least about 5 mm, at least about 6 mm, at least about 10 mm, at least about 12 mm, at least about 15 mm, at least about 18 mm, at least about 20 mm, at least about 25 mm, at least about 30 mm, at least about 50, at least about 75 mm, or at least about 100 mm. In some embodiments the fiber length of the randomly-oriented fiber layer can be at most about 500 mm, at most about 250 mm, at most about 100 mm, at most about 75 mm, at most about 50 mm, at most about 25 mm, at most about 20 mm, at most about 18 mm, at most about 15 mm, at most about 12 mm, at most about 10 mm, at most about 6 mm, at most about 5 mm, or at most about 2 mm.

In some embodiments, the fibers of the randomly-oriented fiber layer can be chopped fibers. In some embodiments, the fibers of the randomly-oriented fiber layer can be continuous. In some embodiments, the continuous fibers can be laid randomly, overlapping themselves.

In some embodiments, the fibers can have a diameter of at least about 1 microns, at least about 2 microns, at least about 3 microns, at least about 4 microns, at least about 5 microns, at least about 6 microns, at least about microns, at least about 10 microns, at least about 15 microns, at least about 17 microns, or at least about 20 microns. In some embodiments, the fibers can have a diameter of at most about 50 microns, at most about 25 microns, at most about 20 microns, at most about 15 microns, at most about 12 microns, at most about 10 microns, at most about 8 microns, at most about 7 microns, at most about 6 microns, or at most about 5 microns. In some embodiments, the cross section of the fibers can be circular, square, rectangular, and/or a combination thereof. In some embodiments, the aspect ratio of the cross section of the fiber (i.e., the shortest length in cross section to longest length in cross section) can be at most about 1, at most about 0.9, at most about 0.75, at most about 0.5, at most about 0.25, or at most about 0.1. In some embodiments, the aspect ratio of the cross section of the fiber (can be at least about 0.1, at least about 0.25, at least about 0.5, at least about 0.75, or at least about 0.9.

In some embodiments, the randomly-oriented fiber layer can have a non-woven construction. As used herein, “non-woven” can refer those defined by ISO standard 9092 and CEN EN 29092.

In some embodiments, the fibers of the random-oriented fiber layer(s) can be uniformly dispersed across the random-oriented fiber layer(s). In some embodiments, the more uniform the fibers are in the random-oriented fiber layer(s), the better the random-oriented fiber layer(s) can induce electrical currents evenly, thereby generating heat evenly across the random-oriented fiber layer(s). Non-uniformly dispersed fibers in the random-oriented fiber layer(s) can cause heating and thus welding to be uneven. In some embodiments, the randomly-oriented fiber layer(s) can have a tensile strength in the machine direction (e.g., 0 degree tensile test) that is substantially similar or identical to that of the tensile strength in the transverse direction (e.g., 90 degree tensile test). The difference in tensile strength in the two directions may be minimal or non-existent if the fibers of the randomly-oriented fiber layer are closer to uniform. In some embodiments, the randomly-oriented fiber layer(s) can have a tensile strength in the machine direction that is within about 50%, within about 40% within about 30%, within about 25%, within about 20%, within about 15%, within about 10%, within about 5%, within about 3%, or within about 1% of the tensile strength in the transverse direction. In some embodiments, the randomly-oriented fiber layer(s) can have a tensile strength in the transverse direction that is within about 50%, within about 40% within about 30%, within about 25%, within about 20%, within about 15%, within about 10%, within about 5%, within about 3%, or within about 1% of the tensile strength in the machine direction. In some embodiments, the fibers of the randomly-oriented fiber layer(s) can be functionalized or include surface treatment. In some embodiments, the fibers of the randomly-oriented fiber layer(s) may be with or without sizing.

In some embodiments, the randomly-oriented fiber layer can have a fiber areal weight of at least about 50 gsm, at least about 75 gsm, at least about 100 gsm, at least about 120 gsm, at least about 140 gsm, at least about 150 gsm, at least about 160 gsm, at least about 180 gsm, at least about 200 gsm, at least about 220 gsm, or at least about 250 gsm. In some embodiments, the randomly-oriented fiber layer can have a fiber areal weight of at most about 500 gsm, at most about 400 gsm, at most about 300 gsm, at most about 250 gsm, or at most about 200 gsm.

In some embodiments, the fibers used in the random-oriented fiber layer(s) may be metallic, ferromagnetic, and/or electrically conductive to induce electrical eddy currents for induction heating. In some embodiments, the fibers can include carbon fiber. In some embodiments, the fibers can be virgin fibers, post-industrial fibers, and/or recycled fibers. In some embodiments, the fibers in the random-oriented fiber layer(s) can be the same or different than the fibers in a unidirectional fiber layer in the lay-up stack(s) and/or laminate(s). In some embodiments, the random-oriented fiber layer(s) can include at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 66 wt. %, at least about 70 wt. %, at least about 75 wt. %, at least about 80 wt. %, at least about 85 wt. %, or at least about 90 wt. % fibers. In some embodiments, the random-oriented fiber layer(s) can include at most about 95 wt. %, at most about 90 wt. %, at most about 85 wt. %, at most about 80 wt. %, at most about 75 wt. %, at most about 70 wt. %, at most about 65 wt. %, at most about 50 wt. %, at most about 45 wt. %, or at most about 40 wt. % fibers. In some embodiments, fiber loading in the random-oriented fiber layer(s) can be the same or different than the fiber loading in a unidirectional fiber layer in the lay-up stack(s) and/or laminate(s).

In some embodiments, the random-oriented fiber layer(s) can include at least one polymer. In some embodiments, the plurality of fibers can be embedded and/or dispersed in the at least one polymer. In some embodiments, the at least one polymer can be a polymer resin such as a neat polymer resin or a polymer resin compounded with additives disclosed herein. In some embodiments, the at least one polymer can be a plurality of polymer particles. In some embodiments, the at least one polymer can include a thermoplastic polymer. In some embodiments, the at least one polymer can be polyamides, polycarbonates, polyacetals, polyphenylene oxides, polyphenylene sulfides, polyarylates, polyesters, polyamideimides, polyimides, polyetherimides, polyimides with a phenyltrimethylindane structure, polysulfones, polyethersulfones, polyetherketones, polyetheretherketones, polyaramids, polyethernitriles, polybenzimidazoles, or combinations thereof. In some embodiments, the at least one polymer can include polyarylether ketone (PAEK), polyphenylene sulfide (PPS), polyethersulfone (PES or PESU), polyethylenimine (PEI), polysulfone (PSU), or combinations thereof. In some embodiments, the at least one polymer can include poly-ether-ketone (PEK), polyether-ether-ketone (PEEK), poly-ether-ether-ketone-ketone (PEEKK), poly-ether-ether-ketone-ketone (PEKK), poly-ether-ketone-ether-ketone-ketone; (PEKEKK), poly-ether-ether-ketone-ether-ketone (PEEKEK), poly-ether-ether-ether-ketone (PEEEK), and poly-ether-diphenyl-ether-ketone (PEDEK), polyaryletherketone (PAEK)-based polymeric material with reactive fend) groups, or combinations thereof. In some embodiments, the PAEK-based polymers can include a range of variants commonly called Low-Melt Polyaryletherketone (LMPAEK™), which can have lower melting temperature for faster processing but comparable mechanical properties compared to other PAEK-based polymers such as PEEK and PEKK. In some embodiments, at least one polymer in the random-oriented fiber layer(s) can be the same or different than the at least one polymer in a unidirectional fiber layer in the lay-up stack(s) and/or laminate(s). In some embodiments, the random-oriented fiber layer(s) can include at least about 5 wt. %, at least about 10 wt. %, at least about 15 wt. %, at least about 20 wt. %, at least about 25 wt. %, at least about 30 wt. %, at least about 34 wt. %, at least about 35 wt. %, at least about 40 wt. %, at least about 50 wt. %, at least about 55 wt. %, at least about 60 wt. %, at least about 65 wt. %, at least about 70 wt. %, at least about 75 wt. %, or at least about 80 wt. % at least one polymer. In some embodiments, the unidirectional fiber layer can include at most about 80 wt. %, at most about 75 wt. %, at most about 70 wt. %, at most about 65 wt. %, at most about 60 wt. %, at most about 55 wt. %, at most about 50 wt. %, at most about 45 wt. %, at most about 40 wt. %, at most about 35 wt. %, at most about 30 wt. %, at most about 25 wt. %, at most about 20 wt. %, at most about 15 wt. %, or at most about 10 wt. % at least one polymer. In some embodiments, polymer loading in the random-oriented fiber layer(s) can be the same or different than the polymer loading in a unidirectional fiber layer in the lay-up stack(s) and/or laminate(s).

In some embodiments, the random-oriented fiber layer(s) can include additives. As stated above, in some embodiments, the at least one polymer can be compounded with additives. In some embodiments, the additives can enhance performance of the consolidated laminate, for example. In some embodiments, the additives can be electrically conductive, dielectric, non-conductive, and/or a combination of other types of additives. In some embodiments, the additives can impart properties other than or in combination with conductivity. In some embodiments, additives can be added to impart insulating properties, thermal properties, chemical properties, and/or mechanical properties. For example, additives can be added to impart strength, toughness, thermal stability, CTE, and/or resistance to environmental degradation, among others. In some embodiments, the additives can be electrically conductive additives for enhanced electrical conductivity of the unidirectional fiber layer. For example, the conductive additives can include carbon particles, carbon black graphene, carbon nanotubes (CNT), milled carbon fiber, milled carbon fiber prepreg, or combinations thereof. In some embodiments, the additives can have a characteristic length or diameter of about 20 nm to 1 micron. In some embodiments, the characteristic length can be the largest dimension of the additive. In some embodiments, the additives can be mixed and/or melt mixed with the at least one polymer before impregnation. In some embodiments, the additives (and at least one polymer) can be well dispersed in the random-oriented fiber layer(s). In some embodiments, the amount (or concentration) of the additives can depend on how well dispersed the additives are in the random-oriented fiber layer(s). For example, the amount (or concentration) for percolation can depend on how well dispersed the additives in the random-oriented fiber layer(s) are. As the degree of additive dispersion increases, the concentration/amount of additive to achieve the percolation threshold concentration for electrical conductivity can decrease.

In some embodiments, the random-oriented fiber layer(s) can be prepared by any method known in the art. For example, the random-oriented fiber layer(s) can be prepared by impregnating a non-woven randomly-oriented fiber fabric with the at least one polymer (and additives). In some embodiments, a non-woven randomly-oriented fiber fabric can be consolidated with a polymer film (e.g., LMPAEK™) or extruded polymer to make the randomly-oriented fiber layer. In some embodiments, the non-woven randomly-oriented fiber fabric can be prepared with polymer fibers such that impregnation of the non-woven randomly-oriented fiber fabric with polymer is not required to form the randomly-oriented fiber layer. In some embodiments, this randomly-oriented fiber layer can further be layered up with other layers (e.g., UD tapes, woven fabrics, etc.) per the desired layup and consolidated into a laminate.

In some embodiments, the non-woven randomly-oriented fiber fabric can have a tensile strength in the machine direction that is substantially similar or identical to that of the tensile strength in the transverse direction. In some embodiments, the non-woven randomly-oriented fiber fabric can have a tensile strength in the machine direction that is within about 50%, within about 40% within about 30%, within about 25%, within about 20%, within about 15%, within about 10%, within about 5%, within about 3%, or within about 1% of the tensile strength in the transverse direction. In some embodiments, the non-woven randomly-oriented fiber fabric can have a tensile strength in the transverse direction that is within about 50%, within about 40% within about 30%, within about 25%, within about 20%, within about 15%, within about 10%, within about 5%, within about 3%, or within about 1% of the tensile strength in the machine direction. In some embodiments, the more uniform the dispersion of the fibers in the non-woven randomly-oriented fiber fabric, then the directional bias of tensile strengths in the two different directions should be minimal or non-existent. In some embodiments, the non-woven randomly-oriented fiber fabric can constitute a porous material form, web, or structure made from entangling discontinuous fibers that are randomly oriented while having a good balance of isotropic properties in the machine and transverse directions, high degree of fiber distribution uniformity across the fabric, and/or minimum to no presence of fiber agglomerates within the fabric, wherein the non-woven structure may be held in place with a minor amount of binder material.

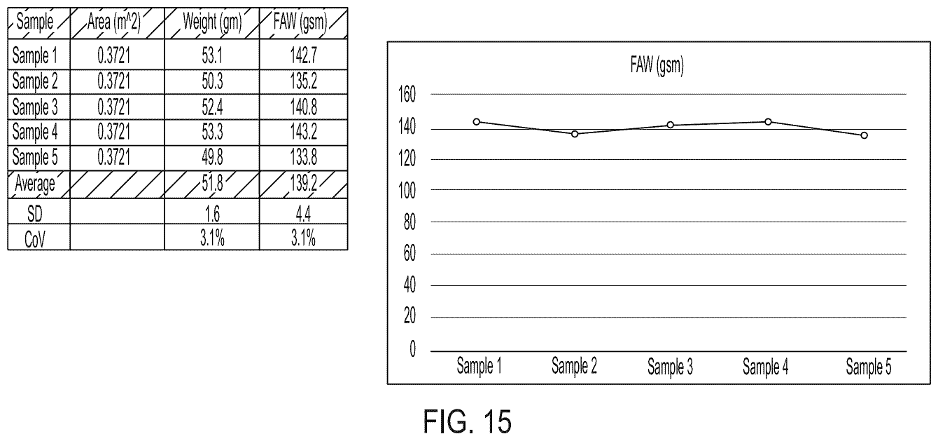

In some embodiments, the non-woven randomly-oriented fiber fabric can have a fiber areal weight of at least about 50 gsm, at least about 75 gsm, at least about 100 gsm, at least about 120 gsm, at least about 140 gsm, at least about 150 gsm, at least about 160 gsm, at least about 180 gsm, at least about 200 gsm, at least about 220 gsm, or at least about 250 gsm. In some embodiments, the non-woven randomly-oriented fiber fabric can have a fiber areal weight of at most about 500 gsm, at most about 400 gsm, at most about 300 gsm, at most about 250 gsm, or at most about 200 gsm. In some embodiments, the random-oriented fiber fabric supplies the fibers disclosed above for the randomly-oriented fiber layer. FIG. 15 illustrates the fiber areal weight (FAW) in gsm for five samples of a carbon fiber non-woven randomly-oriented fiber fabric with a target 140 gsm. The data collected in FIG. 15 was measured from 24″×24″ non-woven 140 gsm carbon fiber fabric.

In some embodiments, the non-woven randomly-oriented fiber fabric can be a fabric with fibers (e.g., carbon fibers) bonded together in a random fiber matrix by a binder. In some embodiments, the binder can be any polymer or polymer combination disclosed herein.

In some embodiments, the random-oriented fiber layer(s) can be produced by preparing a non-woven randomly-oriented fiber fabric with fiber dispersed therein, and impregnating the non-woven randomly-oriented fiber fabric with the at least one polymer (and optional additive). In some embodiments, methods for producing the non-woven randomly-oriented fiber fabric include, but are not limited to, dry processing such as the air laid method wherein the sheet is laid after dispersing the reinforcing fiber by an air stream and/or carding method wherein the sheet is laid after forming the reinforcing fiber with mechanical combing; and wet processing such as the Radright method wherein the reinforcing fiber which has been agitated in water is made into a sheet. In some embodiments, in the dry and wet processing methods, bringing the reinforcing fiber to the state near the monofilament state can include (but are not limited to), in the case of the dry process, provision of an opening bar, vibration of the opening bar, use of finer curd, and/or adjustment of the curd rotation speed; and, in the case of the wet process, adjustment of the conditions used in the agitation of the reinforcing fiber, use of reinforcing fiber dispersion at lower concentration, adjustment of the viscosity of the dispersion, and/or suppression of vortex in the transfer of the dispersion. In some embodiments, the non-woven randomly-oriented fiber fabric may be constituted solely from the reinforcing fiber, or alternatively, the reinforcing fiber may be mixed with at least one polymer disclosed herein, or the reinforcing fiber may be in the form of a mixture with an organic compound or an inorganic compound, or the reinforcing fibers may be filled with a resin component. In some embodiments, the non-woven randomly-oriented fiber fabric may have a small amount of binder (e.g., <5 wt. %) added during production to help handleability and/or holding it together. In some embodiments, the binder can be a low melting temperature polymer or something that is more compatible with the fiber-polymer system/layer being worked on depending on the application.

In some embodiments, the randomly-oriented fiber layer(s) can be obtained by using the non-woven randomly-oriented fiber fabric and applying a pressure with the at least one polymer to a temperature not less than the melting and/or softening temperature to thereby impregnate at least one side of the non-woven randomly-oriented fiber fabric with the at least one polymer (and optional additives).

In some embodiments, at least one of the layers in the lay-up stack(s) and/or laminate(s) can be a woven fabric comprising a plurality of fibers and at least one polymer. The fibers can be any fiber disclosed herein and the at least one polymer can be any polymer disclosed herein. In some embodiments, the woven fabric can be prepared by any method known in the art. In some embodiments, the woven fabric can be a woven fabric made from UD tapes woven together (e.g., woven UD tapes).

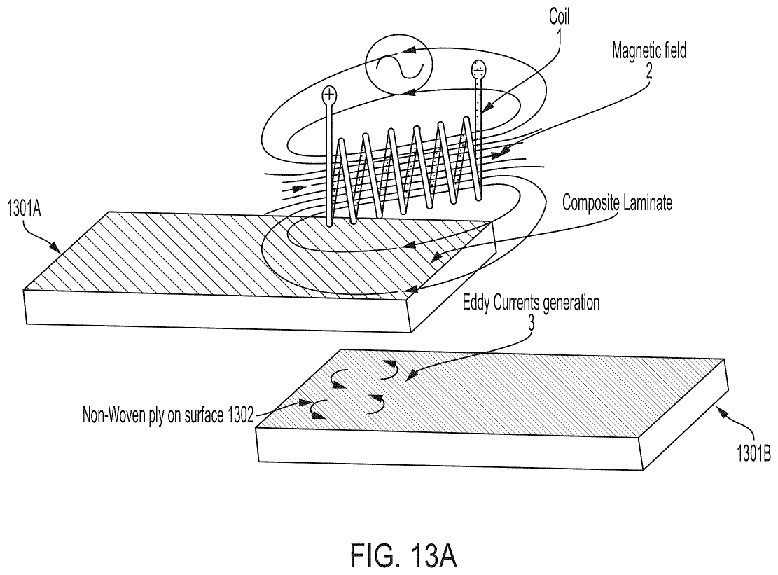

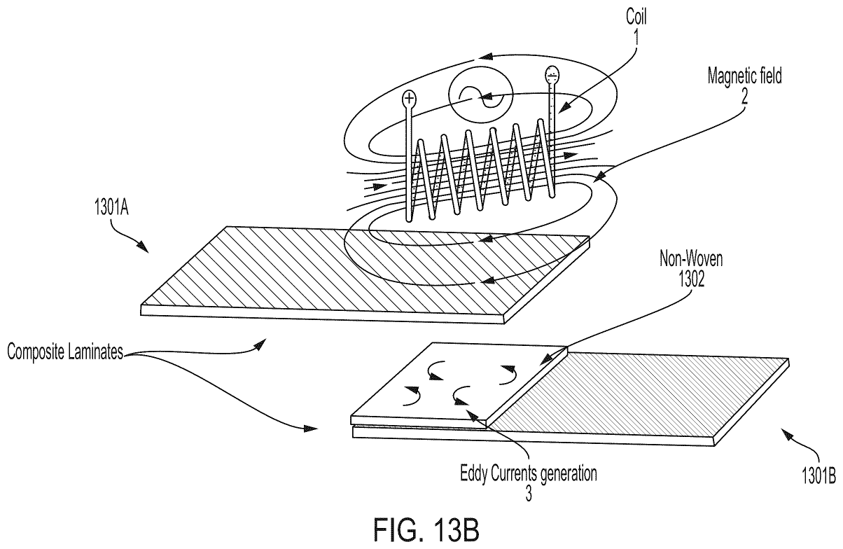

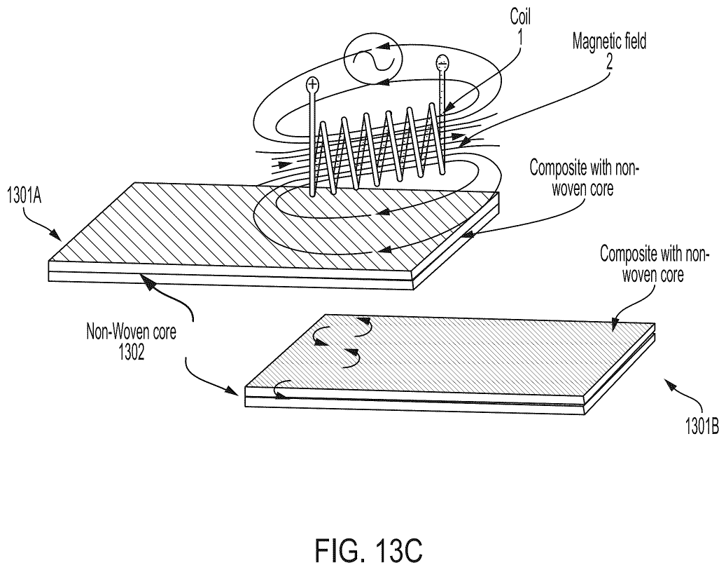

In the lay-up stack(s) and/or laminate(s), any sequence of layers can be accomplished in any order. In addition, any layer (e.g., unidirectional fiber layer, randomly-oriented fiber, woven fiber fabrics) can have any composition disclosed herein for the various layers. In some embodiments, the lay-up and subsequent laminates can have a core with at least one randomly-oriented fiber layer. In some embodiments, the lay-up and subsequent laminates can have at least one randomly-oriented fiber layer dispersed in between other layers (e.g., unidirectional fiber layers and/or woven fiber fabrics). In some embodiments, the lay-up and subsequent laminates can have an external layer with at least one randomly-oriented fiber layer. In some embodiments, this external layer can cover at least a portion (or the whole) external surface of the laminate as shown in FIGS. 13A and 13B. In some embodiments, this external layer with the at least one randomly-oriented fiber layer can be used to join/weld one laminate to another laminate. In some embodiments, a lay-up stack can have at least about 2, at least about 3, at least about 4, at least about 5, at least about 8, at least about 9, at least about 16, at least about 24, or at least about 32 layers. In some embodiments, a lay-up stack can have at most about 2, at most about 3, at most about 4, at most about 5, at most about 8, at most about 9, at most about 16, at most about 24, or at most about 32 layers.

In some embodiments, the lay-up stack is produced by adding each layer (e.g., ply) one by one, and assuring the bond between layers after each additional layer is added (to form a laminate). In some embodiments, the bond between the layers of the lay-up stack can be produced in a single step (to form the laminate). In some embodiments, inducing electrical currents in the randomly-oriented fibers of the randomly-oriented fiber layer(s) via an alternating electromagnetic field can generate heat in the randomly-oriented carbon fibers of the layer(s). In some embodiments, this heat can melt and/or soften the polymers of the randomly-oriented fiber layer(s) by thermal conduction. This melting and/or softening can weld or bond adjacent layers to the randomly-oriented fiber layer. In some embodiments, during the welding process, there can be pressure applied to the overlapping surfaces of the layers and/or laminates to be adjoined. In some embodiments, pressure can be applied to the welding area from the side opposite the induction coil during induction welding. For example, if an induction coil is traversing above the overlapping surfaces being welded, pressure can be applied to the welding area from the bottom of the set up. In some embodiments, the heat generated in the randomly-oriented fibers of the randomly-oriented fiber layer(s) can move through this layer(s) to melt and/or soften polymers in other layers (e.g., adjacent or more distant layers) by thermal conduction. Melting and/or softening of polymers of adjacent layers can bond or weld the adjacent layers together. As such, Applicant discovered that utilizing a randomly-oriented fiber layer(s) within the lay-up stack can allow induction heating to penetrate within the stack (or two laminates) to produce localized heat within the stack (or two laminates) at the randomly-oriented fibers that can then heat the other layers via thermal conduction. In some embodiments, at least a portion of the first layer can overlap with at least a portion of a second layer when the first layer is placed in contact with the second layer, and the first layer can be welded to the second layer at the portion that overlaps each other (i.e., an overlap or lap joint).

In some embodiments, the same principles described herein can be used to join (e.g., weld together) two or more laminates. Such a setup is shown in FIGS. 13A-13C. For example, a first lay-up stack can be prepared and the layers can be bonded together (although they do not have to be bonded together) to form a laminate 1301A. The first lay-up stack can include any of the layers in any sequence described herein. A second lay-up stack can be prepared and the layers can be bonded together (although they do not have to be bonded together) to form a laminate 1301B. The second lay-up stack can include any of the layers in any sequence described herein. At least one of the first or second lay-up stacks or laminates can include at least one randomly-oriented fiber layer 1302. In some embodiments, as shown in FIG. 13A, the at least one randomly-oriented fiber layer can cover an exterior entire surface of the laminate. In some embodiments, in shown in FIG. 13B, the at least one randomly-oriented fiber layer can cover a portion of an exterior surface of the laminate to be joined/welded together with another laminate. In some embodiments, as shown in FIG. 13C, the at least one randomly-oriented fiber layer can be a core and/or internal layer of the laminate. In some embodiments, the stacks or laminates can be contacted together such that the randomly-oriented fiber layer contacts the other stack or laminate. In some embodiments, both the first and second stacks or laminates can include a randomly-oriented fiber layer covering at least a portion of an exterior surface of the respective stack or laminate and the stacks or laminates can be contacted together such that the randomly-oriented fiber layers contact each other. For example, in some embodiments similar to FIG. 13A, both laminates 1301A and 1301B can include at least one randomly-oriented fiber layer 1302 covering an exterior surface of the respective stack or laminate. In other words, laminate 1301A can have an exterior bottom surface similar to randomly-oriented fiber layer 1302 in laminate 1301B of FIG. 13A. In some embodiments similar to those shown in FIG. 13B, both laminates 1301A and 1301B can include at least one randomly-oriented fiber layer 1302 covering a portion of an exterior surface of the respective stack or laminate. In other words, laminate 1301A can have an exterior bottom surface similar to the randomly-oriented fiber layer 1302 in laminate 1301B of FIG. 13B.

In some embodiments, only a portion of a layer of a lay-up stack or laminate can include a randomly-oriented fiber layer. In other words, a portion of a layer of a lay-up stack or laminate can include a randomly-oriented fiber portion and any other layer portion (described herein) such as a UD tape portion. For example, a first lay-up stack can be prepared and the layers can be bonded together (although they do not have to be bonded together) to form a laminate. The first lay-up stack can include any of the layers described herein any sequence. A second lay-up stack can be prepared and the layers can be bonded together (although they do not have to be bonded together) to form a second laminate. The second lay-up stack can include any of the layers described herein in any sequence. At least one of the first and second lay-up stacks or laminates can include an external layer that comprises a randomly-oriented fiber portion and a non-randomly-oriented fiber portion (e.g., UD tape portion, woven fabric portion) described herein. This randomly-oriented fiber portion can be any of the randomly-oriented fiber layers described herein. This randomly-oriented fiber portion of the external layer of the at least one of the first and second lay-ups or laminates can be the portion used to join/weld the lay-ups/laminates together. In other words, the laminates can be contacted together (with pressure) such that a randomly-oriented fiber portion of an external layer of the first and/or second laminate contacts the other stack or laminate. In some embodiments, both the first and second stacks or laminates can include a randomly-oriented fiber portion of their respective external layer and the stacks or laminates can be contacted together such that the randomly-oriented fiber portions of each stack or laminate contact each other for joining/welding. For example, in some embodiments similar to FIG. 13A, both laminates 1301A and 1301B can include at least one randomly-oriented fiber layer 1302 covering an exterior surface of the respective stack or laminate.

As described herein, contacting laminates/stacks for joining/welding can be contacted by applying pressure to at least one of the laminates/stacks during the welding/joining process.

In some embodiments, inducing electrical currents 3 in the randomly-oriented fibers of the randomly-oriented fiber layer via an alternating electromagnetic field 2 (created by alternating currents passing through a conductive coil 1) can generate heat in the randomly-oriented carbon fibers. In some embodiments, this heat can melt and/or soften the polymers of the randomly-oriented fiber layer(s) by thermal conduction. This melting and/or softening can weld or bond the first stack or laminate to the second stack or laminate. In some embodiments, during the welding process, there can be pressure applied to the overlapping surfaces of the layers and/or laminates to be adjoined. In some embodiments, pressure can be applied to the welding area from the side opposite the induction coil during induction welding. For example, if an induction coil is traversing above the overlapping surfaces being welded, pressure can be applied to the welding area from the bottom of the set up. In some embodiments, the heat generated in the randomly-oriented fibers of the randomly-oriented fiber layer(s) can move through this layer(s) to melt and/or soften polymers in other layers (e.g., adjacent or more distant layers) by thermal conduction. Melting and/or softening of polymers of adjacent layers can bond or weld the adjacent layers together (under pressure). In some embodiments, at least a portion of the first laminate can overlap with at least a portion of a second laminate when the first laminate is placed in contact with the second laminate, and the first laminate can be welded to the second laminate at the portion that overlaps each other. As stated above, in some embodiments, at least one of the laminates that overlap can include at least one randomly-oriented fiber layer on the exterior portion of the laminates that overlap. For example, if there is a lap joint, just the portion of the lap joints that overlap can include a randomly-oriented fiber layer (on one or on both laminates facing each other). Such an embodiment would be similar to that shown in FIG. 13B if the top laminate 1301A were joined with the external randomly-oriented fiber layer 1302 of the bottom laminate 1301B. In other words, the at least one randomly-oriented fiber layer can be tailored to be used where joining of one or more layers and/or laminates takes place.

This process can be repeated over and over again for as many stacks/laminates/layers as needed. In some embodiments, the laminates can be any geometry known in the art (e.g., flat or 2D laminates, 3D laminates). In some embodiments, the laminates described herein can be shaped into 3D forms (e.g., stiffeners) that can be welded on to other 2D/flat laminates to form 3D laminates.

As stated above, Applicant discovered that utilizing a at least one randomly-oriented fiber layer can increase the rate of induction heating. In some embodiments, the rate of induction heating of a laminate with at least one randomly-oriented fiber layer can be at least about 1.5 times, at least about 2 times, at least about 2.5 times, at least about 3 times, at least about 3.5 times, at least about 4 times, at least about 4.5 times, or at least about 5 times that of the same laminate without at least one randomly-oriented fiber layer. In other words, the at least one randomly-oriented fiber layer can replace at least one non-randomly-oriented fiber layer of the laminate when comparing the rate of induction heating. In some embodiments, the rate of induction heating a laminate with at least one randomly-oriented fiber layer can be at least about 50 C°/second, at least about 70 C°/second, at least about 75 C°/second, at least about 100 C°/second, at least about 125 C°/second, at least about 150 C°/second, at least about 175 C°/second, at least about 200 C°/second, or at least about 225 C°/second. In some embodiments, the rate of induction heating a laminate with at least one randomly-oriented fiber layer can be at most about 5000 C°/second, at most about 4000 C°/second, at most about 3000 C°/second, at most about 2000 C°/second, at most about 1000 C°/second, at most about 500 C°/second, or at most about 250 C°/second.

Because the at least one randomly-oriented fiber layer can have carbon fibers in any and all directions (i.e., the Z direction in addition to comingled fibers in the X and Y direction), higher eddy current generation was found, thereby increasing the rate and temperature of induction heating as explained in more detail herein.

### Examples

Six samples were created to evaluate the effectiveness of randomly-oriented fiber layers in induction heating performance to see if utilizing randomly-oriented fiber layers would be feasible for induction welding. Induction welding takes much longer so induction heating is a good non-destructive way of understanding the fundamental material properties. The induction heating tests should correlate to how the induction welding performance would be.

The UD tapes utilized in this test were Toray Cetex® TC1225/T800 with about 34 wt. % resin content (66 wt. % carbon fiber content). The randomly-oriented fiber layers were developed from post-industrial carbon fiber (Zoltek Panex 35-Zoltek fiber production waste stream) non-woven fabric with fiber areal weights of 100 gsm and 140 gsm. The non-woven fabric was impregnated with LMPAEK™ film (Aptiv 60 micron) to form the randomly-oriented fiber layers (also referred to as NW_{gsm} or NW in the Table and Figures) with about 66 wt. % carbon fiber content. For the 200 gsm layer, two layers of 100 gsm were combined to form the 200 gsm layer as it is difficult to impregnate a 200 gsm individual layers. As such, two non-woven fabrics with a fiber areal weight of 100 gsm were impregnated with LMPAEK™ film (Aptiv 60 micron) and combined to form the 200 gsm randomly-oriented fiber layer.

### Induction Heating Setup

The following Table 1 illustrates the parameters used for the induction heating set up:

TABLE 1

| Sample dimensions | 300 mm × 300 mm | |
|---|---|---|
| Coil to sample distance | ~5 or 7 | mm |
| Induction heating set-up | Ambrell EasyHeat 8310 with KVE coil | |
| Heating time | 3, 10, or 20 | sec |
| Current | 300-555 | Amp |
| Frequency | +/−300 | kHz |

| | |
|---|---|
| Temperature measurement | Infra-red camera |

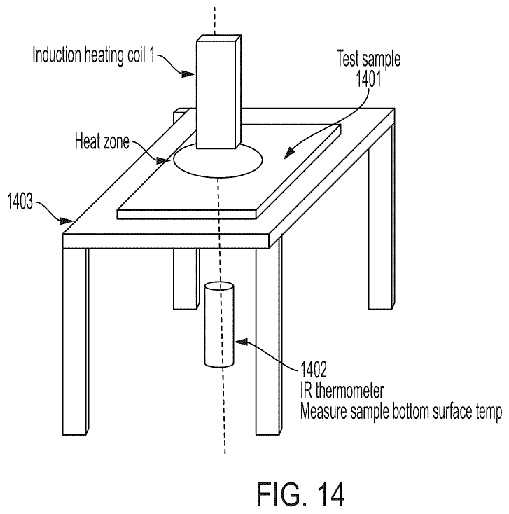

FIG. 14 illustrates an exemplary induction heating set up for the six samples. As shown, a table 1403 with a portion cut out to create a picture frame border with the top surface of the table. The sample laminate 1401 is positioned on top of that picture frame. The induction heating coil 1 is positioned in the center of that laminate from above. The gap between the bottom of the coil and the top surface of the laminate is about 5 or 7 mm. The coil used was enclosed within a fixture so about 5 or 7 mm is the distance between the bottom of the fixture to the top of the laminate. Once the induction heating trial starts, there is an infrared camera and/or thermometer/thermocouple 1402 mounted underneath the table that is facing upwards pointing towards the bottom surface of the laminate to measure the temperature of the laminate surface opposite the surface that is facing the induction coil.

### Measuring Peak Temperature

The temperatures are measured using an infrared thermometer at the bottom of the laminate with the coil above the laminate.

### Imaging Induction Heating

The induction heating images of samples C1-C6 have the same scale of 20-100° C. such that direct comparison can be made for the heat spot sizes of the samples. The point in time chosen for the image was when Tmax was closest to 100° C.

All laminates that were tested were produced in a single static press cycle. A static press cycle in thermoplastic carbon fiber composites can involve placing layers of carbon fiber reinforcement within a thermoplastic matrix into a mold. The mold can then be subjected to heat and pressure in a static manner. During this cycle, the material can be heated to a temperature where the thermoplastic matrix becomes molten, allowing it to flow and impregnate the carbon fibers. The application of pressure can ensure proper consolidation of the composite structure. After reaching the desired time and temperature, the mold can be cooled, solidifying the thermoplastic matrix and forming the final composite part/laminate.

The lay-up sequence for each sample, the induction heating current, time, and coil (KVE) distance, as well as the panels tested for peak temperature each lay-up are listed in the Tables 2A and 2B below. Panels 1 and 2 refer to two separate samples (i.e., replicates) for each of Samples C1-C6. Thus, there were two samples tested for each of C1-C6 and the average is the average of these two samples/panels as shown in Table 2A. In addition, the same panel 1 tested at 500 amp/3 sec is also the panel 1 tested at 300 amp/10 sec and 300 amp/20 sec as shown in Table 2A. For example, testing the same panel at different amps and times can illustrate the difference on peak temperature as a function of the different induction heating parameters. A second set of tests were run for Samples C1-C5 and those results are in Table 2B.

TABLE 2A

| | | | | | Avg | | | |
|---|---|---|---|---|---|---|---|---|
| | | | Panel 1 | Panel 2 | (Panels 1-2) | | Panel 1 | Panel 1 |
| | | | 500 amp/ | 500 amp/ | 500 amp/ | | 300 amp/ | 300 amp/ |
| | | Current/ | 3 sec | 3 sec | 3 sec | | 10 sec | 20 sec |
| | | time | 5 mm | 5 mm | 5 mm | | 5 mm | 5 mm |
| | | Coil (KVE) | Peak | Peak | Average | | Peak | Peak |
| TEST 1 | # | distance | temp | temp | temp | | temp | temp |
| Lay-up | plies | Sample | (C.) | (C.) | (C.) | | (C.) | (C.) |
| [45/0/−45/90/90/−45/0/45/45/ | 16 | C1 | 126 | 137 | 131.5 | | 130 | 191 |
| 0/−45/90/90/−45/0/45] | | | | | | | | |
| [45/0/−45/90/90/−45/0/ | 16 | C2 | 214 | 203 | 208.5 | Peak | 227 | NA |
| NW₁₄₀/NW₁₄₀/ | | | | | | Temp % | | |
| 0/−45/90/90/−45/0/45] | | | | | | increase | | |
| | | | | | | from C1: | | |
| | | | | | | 159% | | |
| [45/−45/45/−45/0/−45/45/−45/45] | 9 | C3 | 125 | 157 | 141 | | 131 | NA |
| [45/−45/45/−45/ | 9 | C4 | 255 | 252 | 253.5 | % | 263 | NA |
| NW₁₄₀/−45/45/−45/45] | | | | | | increase | | |
| | | | | | | from C3: | | |
| | | | | | | 180% | | |
| [45/−45/45/−45/ | 9 | C5 | 263 | 273 | 268 | % | 287 | NA |
| NW₂₀₀/−45/45/−45/45] | | | | | | increase | | |
| | | | | | | from C3: | | |
| | | | | | | 190% | | |
| [0/90/45/−45/NW₁₄₀/ | 10 | C6 | 263 | 288 | 275.5 | | 259 | NA |
| NW₁₄₀/−45/45/90/0] | | | | | | | | |

TABLE 2B

| | | | | | | Avg | |
|---|---|---|---|---|---|---|---|
| | | | | Panel 1 | Panel 2 | (Panels 1-2) | |
| | | | Current/ | 555 amp/ | 555 amp/ | 555 amp/ | |
| | | | time | 3 sec | 3 sec | 3 sec | |
| | | | Coil | Peak | Peak | Average | |
| TEST 2 | # | | (KVE) | temp | temp | temp | |
| Lay-up | plies | Sample | distance | (C.) | (C.) | (C.) | |
| [45/0/−45/90/90/−45/0/45/45/ | 16 | C1 | 5 mm | 131 | 107 | 118.8 | |
| 0/−45/90/90/−45/0/45] | | | | | | | |
| [45/0/−45/90/90/−45/0/ | 16 | C2 | 5 mm | 209 | 189 | 198.8 | Peak |
| NW₁₄₀/NW₁₄₀/ | | | | | | | Temp % |
| 0/−45/90/90/−45/0/45] | | | | | | | increase |
| | | | | | | | from C1: |
| | | | | | | | 167% |
| [45/−45/45/−45/0/−45/45/−45/45] | 9 | C3 | 7 mm | 77 | 94 | 85.8 | |
| [45/−45/45/−45/ | 9 | C4 | 7 mm | 166 | 181 | 173 | % |
| NW₁₄₀/−45/45/−45/45] | | | | | | | increase |
| | | | | | | | from C3: |
| | | | | | | | 202% |
| [45/−45/45/−45/ | 9 | C5 | 7 mm | 196 | 232 | 214.2 | % |
| NW₂₀₀/−45/45/−45/45] | | | | | | | increase |
| | | | | | | | from C3: |
| | | | | | | | 250% |

As shown in the above tables, the percent increase is calculated by: ((the average peak temperature of the sample minus the average peak temperature of the baseline sample)/the average peak temperature of the baseline sample)) times 100 plus 100.

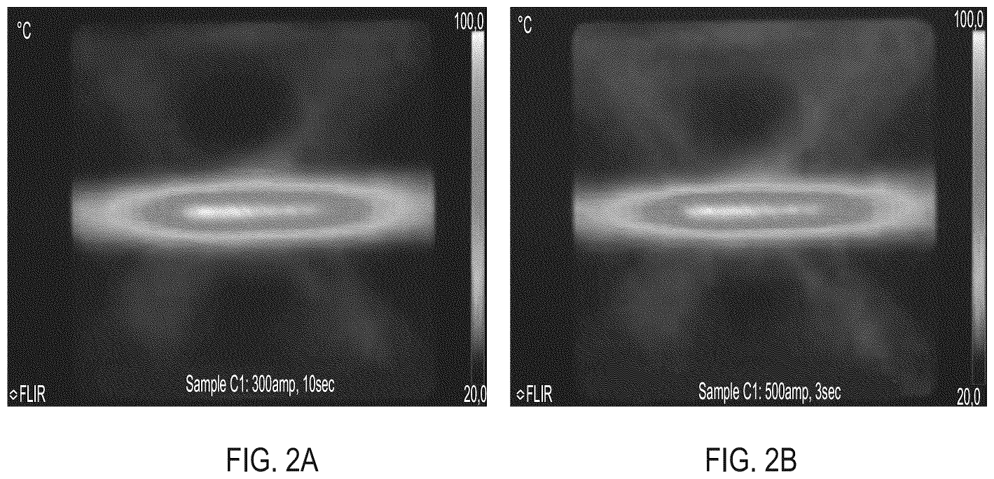

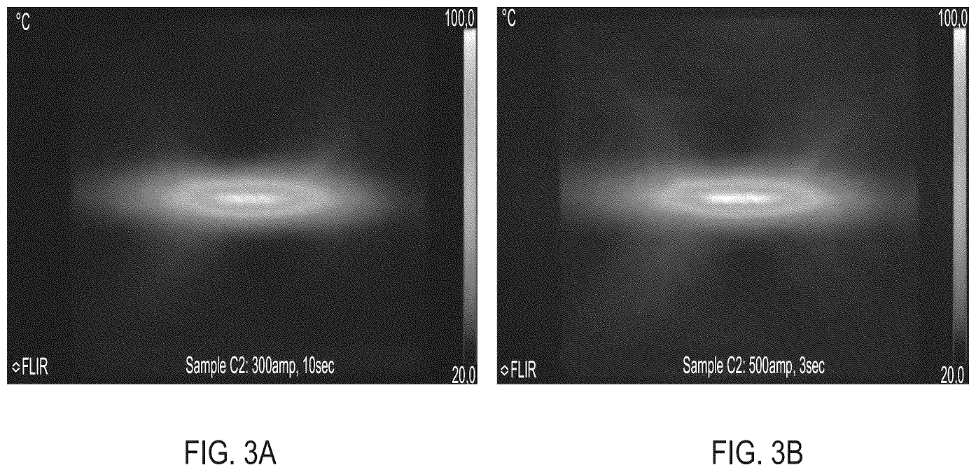

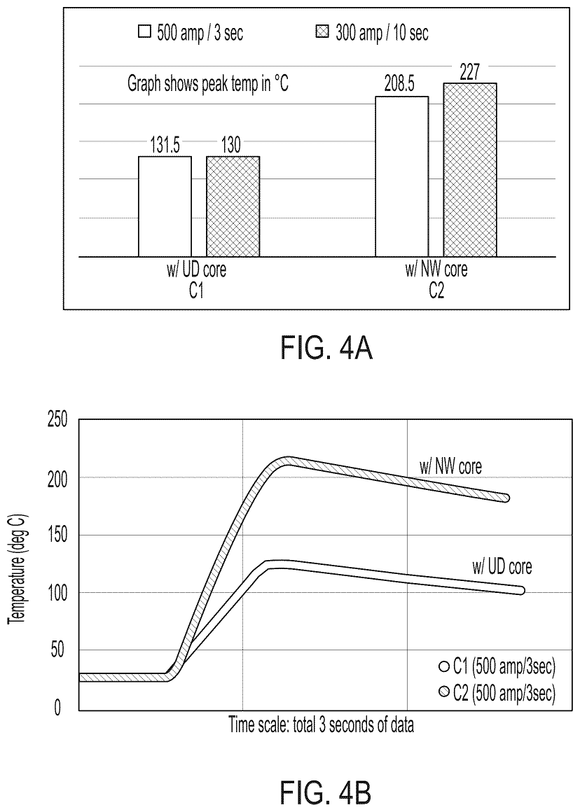

Sample C1 is a baseline laminate with unidirectional carbon fiber-based tapes. The fibers in the UD tape are continuous. Thus, when heating the material there are certain losses that happen in the direction of the orientation of the fiber. Ideally, the heat should be concentrated to get a better welding joint instead of having heat losses. Samples C1 and C2 form one sample set testing a laminate with all unidirectional carbon fiber tapes (C1) against a laminate with randomly-oriented fiber layers in the middle of the laminate replacing two unidirectional tape layers (C2). As shown in FIGS. 2A-2B, the heat zone of the control laminate is elongated horizontally. When the UD tape core of the laminate is replaced with randomly-oriented fiber layers in sample C2, the heat zone as shown in FIGS. 3A-3B is much more concentrated and less elongated compared to those of sample C1. As shown in FIG. 4A, there was about a 159% increase in average peak temperature when the laminate had a randomly-oriented fiber layer core. This is a significant improvement in peak temperature in the same time span. In addition, FIG. 4B illustrates that the slope of heating was significantly increased when the laminate had a randomly-oriented fiber layer core. In addition, the rate of induction heating was calculated for Samples C1 and C2. The rate of induction heating, as disclosed herein, can be calculated by determining the slopes of the rate of induction heating curves. The slopes of these curves can be determined by a taking a point when the temperature reaches about 50° C. and a point when the temperature reaches about 100° C. along with the corresponding time scale and calculating slope (i.e., rate). In other words, the rate of induction heating can be calculated by the (change in temperature from about 100° C. to about 50° C.)/(change in time to go from 50° C. to 100° C.). For example, the rate of induction heating for samples C1 and C2 is shown below in Table 3:

TABLE 3

| | | | | | Rate of |
|---|---|---|---|---|---|
| | | | | | Induction |
| | | | | | Heating |
| Test 1 | Temperature | Time | Temperature | Time | Slope |
| Sample | (C.) | (s) | (C.) | (s) | (degC./sec) |
| C1 | 50 | 3.4 | 102 | 4.9 | 34.7 |
| C2 | 50.3 | 3.2 | 101.9 | 3.9 | 73.7 |

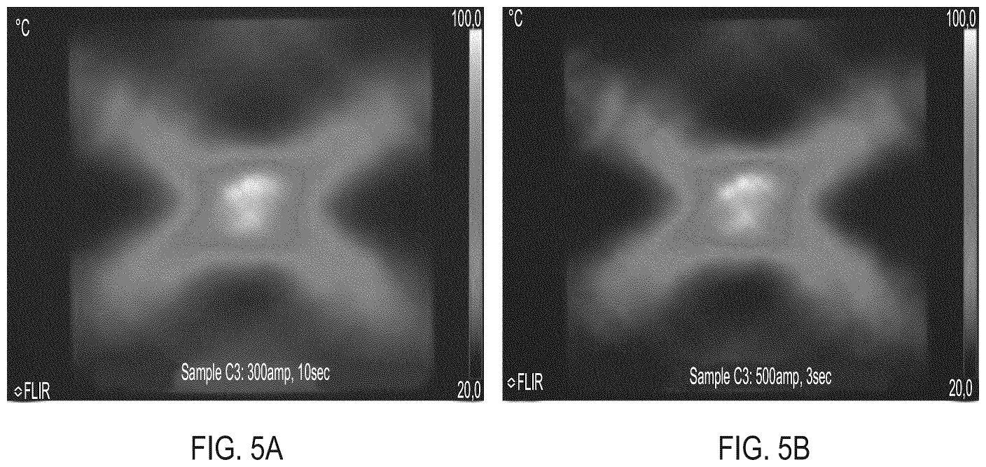

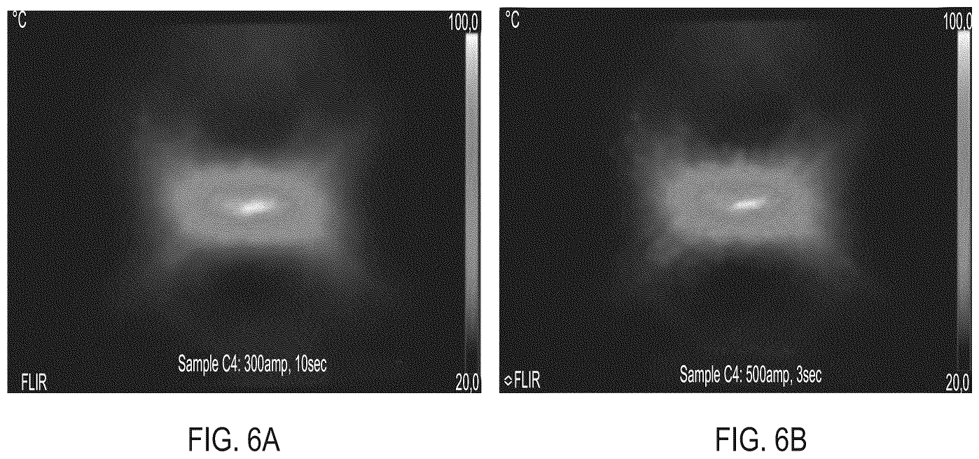

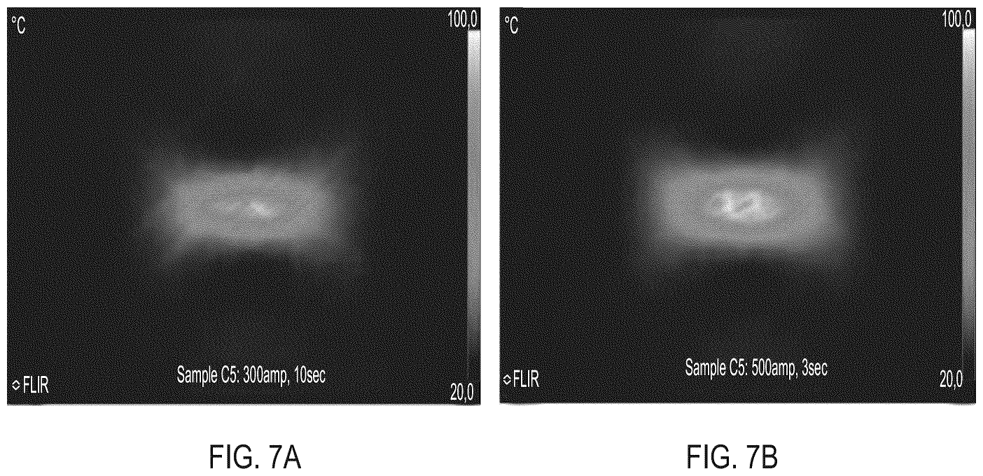

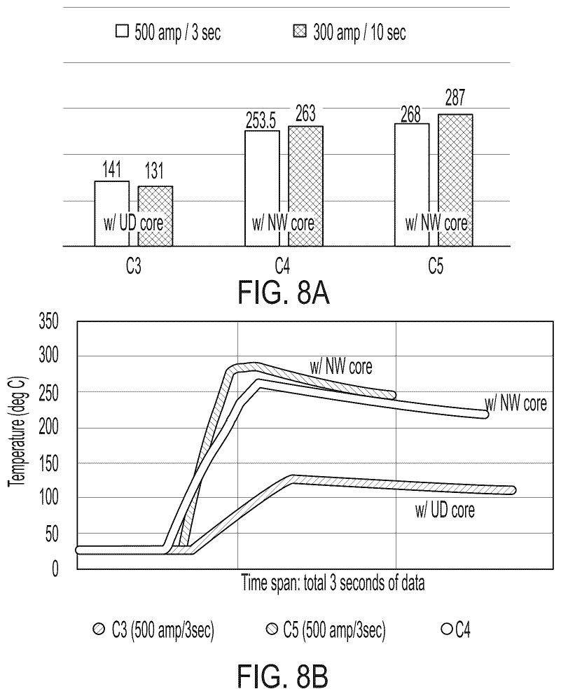

Samples C3, C4, and C5 form a second sample set testing a laminate with all unidirectional carbon fiber tapes (C3) against a laminate with a randomly-oriented fiber layer with two different gsm fiber areal weights in the middle of the laminate replacing one unidirectional tape layer (C4 and C5). In sample C3, there is a core with a 0 degree orientation of unidirectional tape and this is replaced with a randomly-oriented fiber layer with a gsm fiber areal weight of 140 in sample C4 and 200 in sample C5. In addition, all the other unidirectional fiber layers are at +/−45 degree orientation to maximize conductive heat loss in the fiber direction. As shown in FIGS. 5A-5B, the heat zone is a large “X”. In FIGS. 6A-6B (C4) and FIGS. 7A-7B, the heat zone is much more concentrated and the length of the arms of the “X” is significantly reduced, thereby illustrating the reduction in heat loss in the laminate. In addition, increasing the gsm fiber areal weight of sample weight of the randomly-oriented fiber layer from 140 to 200 increases the reduction in heat loss profile and improved induction heating results. As shown in FIG. 8A, there was almost a 200% increase in average peak temperature when the laminate had a randomly-oriented fiber layer core. This is a significant improvement in peak temperature in the same time span. In addition, FIG. 8B illustrates that the slope of heating was significantly increased when the laminate had a randomly-oriented fiber layer core. Thus, utilizing a randomly-oriented fiber layer in the laminate can achieve a higher peak temperature in a shorter span of time than a traditional UD tape laminate. Although the time span is only 3 seconds, induction welding is fairly slow and so these improvements identified in induction heating can become magnified in induction welding. The rate of induction heating for Samples C3, C4, and C5 is shown in Table 4 below:

TABLE 4

| | | | | | Rate of |
|---|---|---|---|---|---|
| | | | | | Induction |
| | | | | | Heating |
| Test 1 | Temperature | | Temperature | | Slope |
| Sample | (C.) | Time | (C.) | Time | (degC./sec) |
| C3 | 49.4 | 4.2 | 99.8 | 5.8 | 31.5 |
| C4 | 50 | 3.7 | 100.3 | 4.2 | 100.6 |
| C5 | 52.3 | 3.4 | 97.6 | 3.6 | 226.5 |

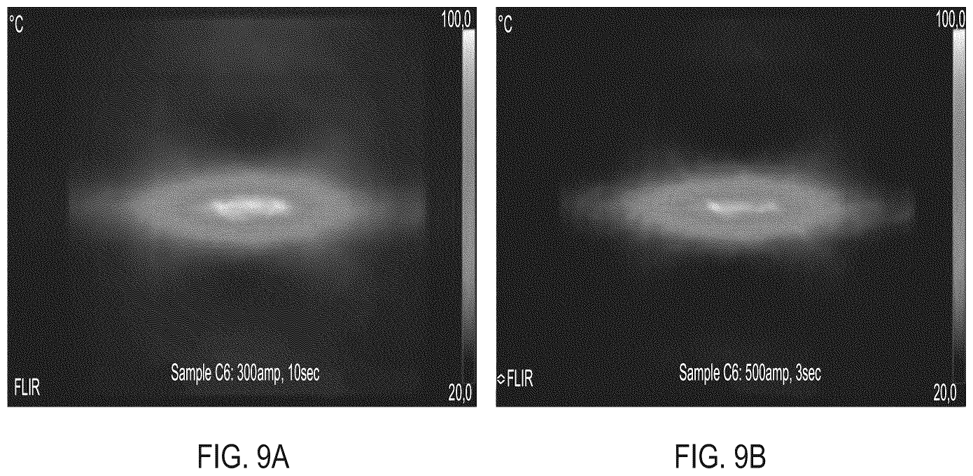

Sample C6 is another sample testing a laminate with unidirectional fiber layers oriented quasi-isotropic with randomly-oriented fiber layers between the set of unidirectional fiber layers. FIGS. 9A-9B illustrate a concentrated heating zone profile.

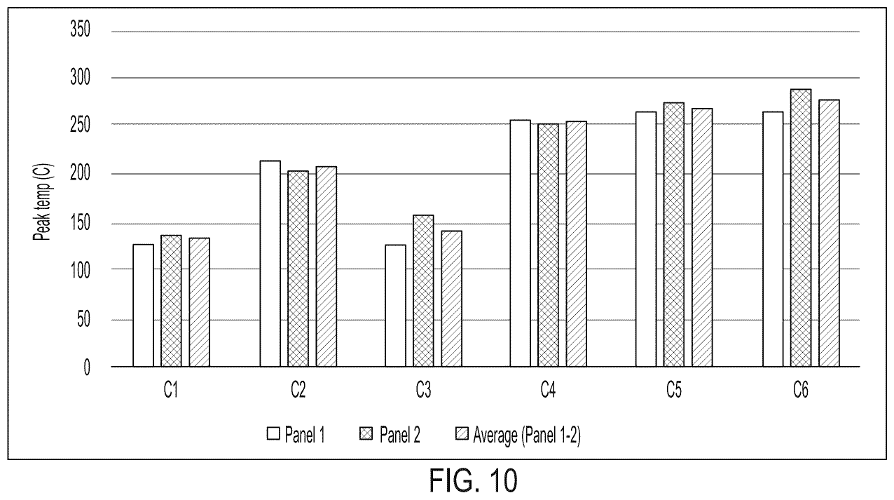

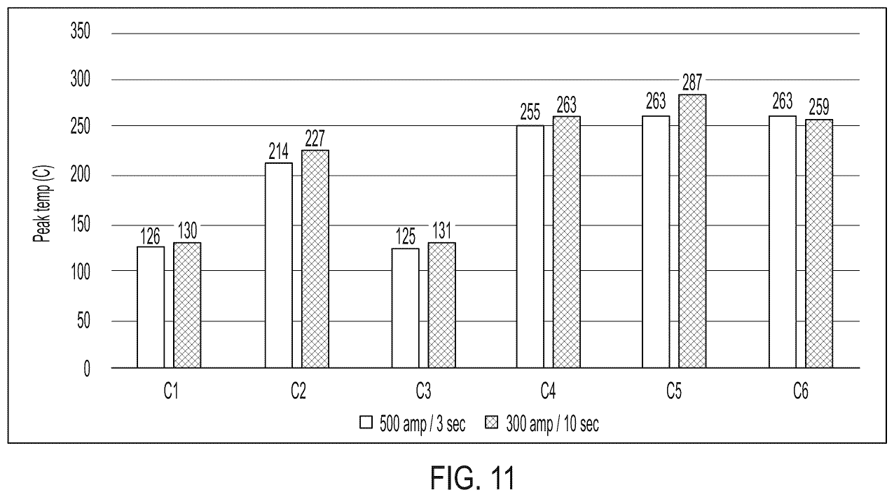

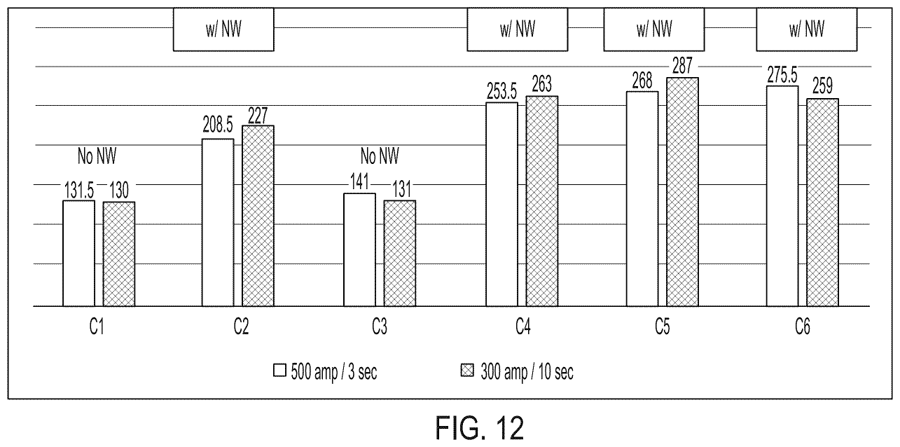

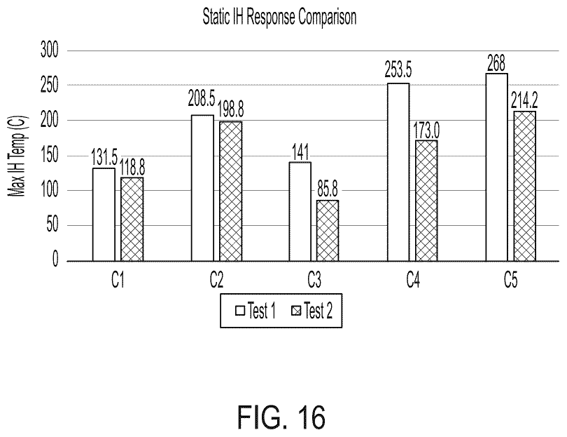

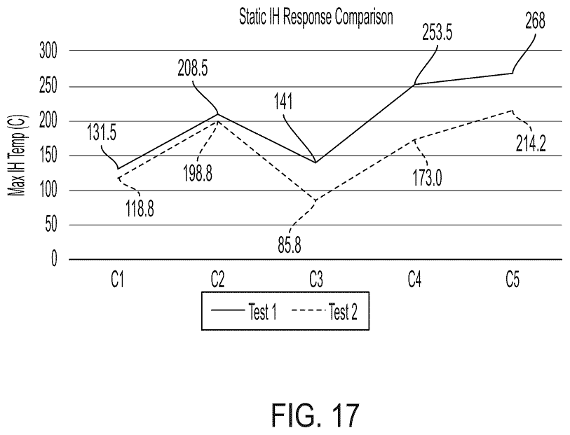

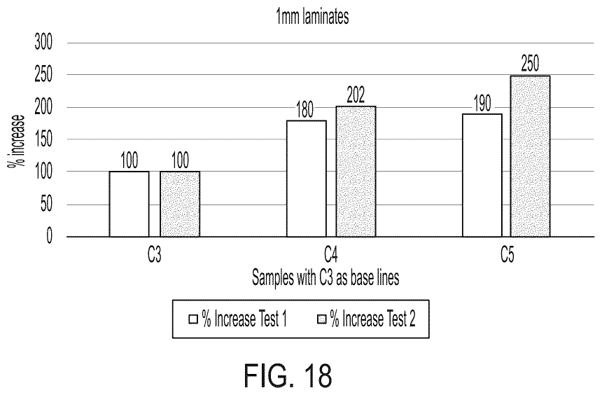

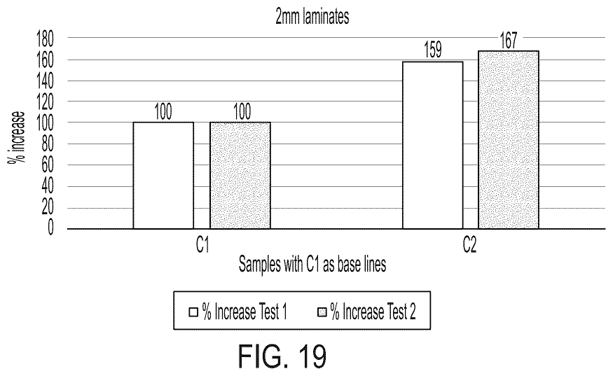

FIGS. 10-12 illustrate bar graphs of the measured peak temperatures of the various samples C1-C6 of Test 1. FIG. 16 illustrates a bar graph showing the average peak temperature measured from samples C1-C5 for both Tests 1 and 2. FIG. 17 illustrates a line graph showing the average peak temperature measured from samples C1-C5 for both Tests 1 and 2. FIG. 18 illustrates a bar graph showing the peak temperature percent increase of samples C4 and C5 compared to baseline sample C3 for Tests 1 and 2. FIG. 19 illustrates a bar graph showing the peak temperature percent increase of sample C2 compared to baseline sample C1 for Tests 1 and 2.

As shown above, Applicant has demonstrated that utilizing randomly-oriented fiber layers can improve induction heating efficiency: (1) due to higher order of fiber-fiber contact compared to UD tapes; (2) by reducing conductive heating losses in composite laminates; and/or (3) through disruption of eddy currents formed in generated electromagnetic fields.

Specifically, Applicant has demonstrated that utilizing randomly-oriented fiber layers can increase peak temperatures of the laminate compared to those that can be achieved over the standard UD tape based laminate structure. In some embodiments, utilizing randomly-oriented fiber layers can increase peak temperatures of the laminates by at least about 10%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 100%, at least about 125%, at least about 150%, at least about 175%, at least about 200%, at least about 225%, or at least about 250% compared to those that can be achieved with a standard UD tape-based laminate structure without a randomly-oriented fiber layer.

As stated above, the randomly-oriented fiber layer(s) can contribute to significant reduction in conductive heat losses that may be attributed to the highly oriented unidirectional fiber in the tapes. Furthermore, the randomly-oriented fiber layer(s) can increase the rate of induction heating response resulting in improved efficiencies and reduced cycle time in induction welding operations. Additionally, the use of randomly-oriented fiber layer(s) might benefit in better formability and draw-down rations in forming complex 3D parts.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

1. A method of producing a thermoplastic composite comprising:
preparing a first laminate comprising:
a first layer comprising a first plurality of unidirectional fibers and a first polymer; and
a second layer comprising randomly-oriented carbon fibers and a second polymer, wherein the second layer covers at least a portion of a surface of the first layer;
preparing a second laminate comprising:
a third layer comprising a second plurality of unidirectional fibers and a third polymer;
placing the first laminate in contact with the second laminate such that the second layer of the first laminate contacts the second laminate;
inducing electrical currents in the randomly-oriented carbon fibers of the second layer via an alternating electromagnetic field, thereby generating heat in the randomly-oriented carbon fibers of the second layer; and
melting and/or softening the first, second, and third polymer with the heat generated by the randomly-oriented carbon fibers, thereby welding the first laminate to the second laminate.

2. The method of claim 1, wherein the second laminate further comprises a fourth layer comprising randomly-oriented carbon fibers and a fourth polymer.

3. The method of claim 2, further comprising placing the first laminate in contact with the second laminate such that the fourth layer of the second laminate contacts the second layer of the first laminate.

4. The method of claim 3, further comprising inducing electrical currents in the randomly-oriented carbon fibers of the fourth layer via an alternating electromagnetic field, thereby generating heat in the randomly-oriented carbon fibers of the fourth layer.

5. The method of claim 4, further comprising melting and/or softening the first, second, third, and fourth polymers with the heat generated by the randomly-oriented carbon fibers of the second and fourth layers, thereby welding the first laminate to the second laminate.

6. The method of claim 1, wherein at least a portion of the first laminate overlaps with at least a portion of the second laminate when the first laminate is placed in contact with the second laminate, and the first laminate is welded to the second laminate at the portions that overlap.

7. The method of claim 1, wherein the randomly-oriented carbon fibers are discontinuous and/or chopped carbon fibers.

8. The method of claim 1, wherein the first and second plurality of unidirectional fibers comprises carbon fibers, glass fibers, or combinations thereof.

9. The method of claim 1, wherein the first, second, third, and/or fourth polymers are the same polymer.

10. The method of claim 1, wherein welding the first laminate to the second laminate includes applying pressure to the first and/or second laminate to push the first laminate and second laminate together.

11. A method of producing a thermoplastic composite comprising:
preparing a lay-up comprising:
a first layer comprising a first plurality of unidirectional fibers and a first polymer;
a second layer comprising a second plurality of unidirectional fibers and a second polymer; and
and at least one third layer comprising randomly-oriented carbon fibers and a third polymer, wherein the at least one third layer is between the first layer and the second layer in the lay-up;
inducing electrical currents in the randomly-oriented carbon fibers of the at least one third layer via an alternating electromagnetic field, thereby generating heat in the randomly-oriented carbon fibers of the at least one third layer; and
melting and/or softening the first, second, and third polymer of the third layer with the heat generated by the randomly-oriented carbon fibers, thereby welding the at least one third layer to the first layer and the second layer.

12. The method of claim 11, wherein the randomly-oriented carbon fibers are discontinuous and/or chopped carbon fibers.

13. The method of claim 11, wherein the first and second plurality of unidirectional fibers comprises carbon fibers, glass fibers, or combinations thereof.

14. The method of claim 11, wherein the first, second, and third polymers are the same polymers.

15. The method of claim 11, wherein at least a portion of the first layer overlaps with at least a portion of the at least one third layer, at least a portion of the second layer overlaps with at least a portion of the at least one third layer, and the at least one third layer is welded to the first layer and the second layer at the portions that overlap.

16. A thermoplastic composite comprising:
a first layer comprising a first plurality of unidirectional fibers and a first polymer;
a second layer comprising a second plurality of unidirectional fibers and a second polymer; and
at least one third layer comprising randomly-oriented carbon fibers and a third polymer, wherein the at least one third layer is between the first layer and the second layer and the at least one third layer is welded to the first and second layers.

17. The composite of claim 16, wherein the at least one third layer comprises at least two layers comprising randomly-oriented carbon fibers and a third polymer, wherein one of the at least two layers is welded to the first layer and the other one of the at least two layers is welded to the second layer.

18. The composite of claim 16, wherein one of the at least two layers covers a portion of a surface of the first layer, and the other one of the at least two layers covers a portion of a surface of the second layer.

19. The composite of claim 16, wherein the randomly-oriented carbon fibers are discontinuous and/or chopped carbon fibers.

20. The composite of claim 16, wherein the first and second plurality of unidirectional fibers comprises carbon fibers, glass fibers, or combinations thereof.

21. The composite of claim 16, wherein the first, second, and third polymers are the same polymers.

22. The composite of claim 16, wherein the welding is formed from induction welding.

23. A method of producing a thermoplastic composite comprising:
preparing a first laminate comprising:
a first layer comprising a first woven fabric comprising a first plurality of fibers and a first polymer; and
a second layer comprising randomly-oriented carbon fibers and a second polymer, wherein the second layer covers at least a portion of a surface of the first layer;
preparing a second laminate comprising:
a third layer comprising a second woven fabric comprising a second plurality of fibers and a third polymer;
placing the first laminate in contact with the second laminate such that the second layer of the first laminate contacts the second laminate;
inducing electrical currents in the randomly-oriented carbon fibers of the second layer via an alternating electromagnetic field, thereby generating heat in the randomly-oriented carbon fibers of the second layer; and
melting and/or softening the first, second, and third polymer with the heat generated by the randomly-oriented carbon fibers, thereby welding the first laminate to the second laminate.

24. The method of claim 23, wherein the second laminate further comprises a fourth layer comprising randomly-oriented carbon fibers and a fourth polymer.

25. The method of claim 24, further comprising placing the first laminate in contact with the second laminate such that the fourth layer of the second laminate contacts the second layer of the first laminate.

26. The method of claim 25, further comprising inducing electrical currents in the randomly-oriented carbon fibers of the fourth layer via an alternating electromagnetic field, thereby generating heat in the randomly-oriented carbon fibers of the fourth layer.

27. The method of claim 26, further comprising melting and/or softening the first, second, third, and fourth polymers with the heat generated by the randomly-oriented carbon fibers of the second and fourth layers, thereby welding the first laminate to the second laminate.

28. The method of claim 23, wherein at least a portion of the first laminate overlaps with at least a portion of the second laminate when the first laminate is placed in contact with the second laminate, and the first laminate is welded to the second laminate at the portions that overlap.

29. The method of claim 23, wherein the randomly-oriented carbon fibers are discontinuous and/or chopped carbon fibers.

30. The method of claim 23, wherein the first and second plurality of unidirectional fibers comprises carbon fibers, glass fibers, or combinations thereof.

31. The method of claim 23, wherein the first, second, third, and/or fourth polymers are the same polymer.

32. A method of producing a thermoplastic composite comprising:
preparing a first laminate comprising:
a first layer comprising a first plurality of unidirectional fibers and a first polymer; and
a second layer comprising a first portion and a second portion, wherein the first portion comprises randomly-oriented carbon fibers and a second polymer and the second portion comprises a second plurality of unidirectional fibers and a third polymer;
preparing a second laminate comprising:
a third layer comprising a third plurality of unidirectional fibers and a fourth polymer;
placing the first laminate in contact with the second laminate such that the second layer of the first laminate contacts the second laminate;
inducing electrical currents in the randomly-oriented carbon fibers of the second layer via an alternating electromagnetic field, thereby generating heat in the randomly-oriented carbon fibers of the second layer; and
melting and/or softening the first, second, third, and fourth polymers with the heat generated by the randomly-oriented carbon fibers, thereby welding the first laminate to the second laminate.

33. The method of claim 32, wherein the second laminate further comprises a fourth layer comprising a first portion and a second portion, wherein the first portion comprises randomly-oriented carbon fibers and a fifth polymer and the second portion comprises a fourth plurality of unidirectional fibers and a sixth polymer

34. The method of claim 33, further comprising placing the first laminate in contact with the second laminate such that the first portion of the second layer of the first laminate contacts the first portion of the fourth layer of the second laminate.

35. The method of claim 34, further comprising inducing electrical currents in the randomly-oriented carbon fibers of the fourth layer via an alternating electromagnetic field, thereby generating heat in the randomly-oriented carbon fibers of the fourth layer.

36. The method of claim 35, further comprising melting and/or softening the first, second, third, fourth, fifth, and sixth polymers with the heat generated by the randomly-oriented carbon fibers of the second and fourth layers, thereby welding the first laminate to the second laminate.

37. The method of claim 32, wherein at least a portion of the first laminate overlaps with at least a portion of the second laminate when the first laminate is placed in contact with the second laminate, and the first laminate is welded to the second laminate at the portions that overlap.

38. The method of claim 32, wherein the randomly-oriented carbon fibers are discontinuous and/or chopped carbon fibers.

39. The method of claim 32, wherein the first and second plurality of unidirectional fibers comprises carbon fibers, glass fibers, or combinations thereof.

40. The method of claim 32, wherein the first, second, third, fourth, fifth, and/or sixth polymers are the same polymer.

41. The method of claim 32, wherein welding the first laminate to the second laminate includes applying pressure to the first and/or second laminate to push the first laminate and second laminate together.
